(19) United States
(12) Patent Application Publication
(10) Pub. No.: US 2025/0387705 A1
(43) Pub. Date: Dec. 25, 2025

(54) VIRTUAL ENVIRONMENT DISPLAY CONTROL

(71) Applicant: TENCENT TECHNOLOGY (SHENZHEN) COMPANY LIMITED, Shenzhen (CN)

(72) Inventor: Yizhou LI, Shenzhen (CN)

(73) Assignee: TENCENT TECHNOLOGY (SHENZHEN) COMPANY LIMITED, Shenzhen, GD (CN)

(21) Appl. No.: 19/310,447

(22) Filed: Aug. 26, 2025

Related U.S. Application Data
(63) Continuation of application No. PCT/CN2024/083642, filed on Mar. 25, 2024.

(30) Foreign Application Priority Data
May 29, 2023 (CN) 202310621895.X

(51) Int. Cl. A63F 13/5252; G06T 19/00

(52) U.S. Cl. CPC A63F 13/5252; G06T 19/003

(57) ABSTRACT

In a method for displaying a virtual environment, a first virtual scene is output for display based on a first view perspective of a first virtual object. The first view perspective is switched to a second view perspective based on a first perspective switching operation. A field of view of the second view perspective is different from a field of view of the first view perspective. A second virtual scene is output for display based on the second view perspective of the first virtual object in the virtual environment and whether a second virtual object in the field of view of the second view perspective is in the field of view of the first view perspective. Inclusion of the second virtual object in the second virtual scene is based on whether the second virtual object is included in the field of view of the first view perspective.

### RELATED APPLICATIONS

The present application is a continuation of International Application No. PCT/CN2024/083642, filed on Mar. 25, 2024, which claims priority to Chinese Patent Application No. 202310621895.X, filed on May 29, 2023. The entire disclosures of the prior applications are hereby incorporated by reference.

### FIELD OF THE TECHNOLOGY

This application relates to the field of computer technologies, including a method for displaying a virtual world.

### BACKGROUND OF THE DISCLOSURE

For an application that supports a virtual object to observe a virtual world at different perspectives, a perspective switching or a perspective change may cause a user to receive additional information that is not to be received.

For example, in a first-person game, a user A plays the game from a first-person perspective of the virtual object by default. After the user A selects a fire-drawing action performance designed to provoke an enemy, display content of a user interface (UI) is switched from a game picture from the first-person perspective to a game picture from a third-person perspective, so as to view the fire-drawing action performed by the virtual object controlled by the user A. However, a virtual object that cannot be observed by the user A as a result of being blocked from the first-person perspective may be observed by the user A due to being no longer blocked from the third-person perspective. In this way, the user A has a chance to observe the virtual object that cannot be observed by the default first-person perspective, and a game situation is more beneficial to the user A. This phenomenon seriously affects balance of the application and user experience.

Therefore, how to resolve an adverse impact caused by the perspective switching or the perspective change, and avoid presenting information that the user is not to receive to the user is a problem that needs to be resolved.

### SUMMARY

Aspects of this disclosure include a method for displaying a virtual world, an apparatus for displaying a virtual world, and a non-transitory computer-readable storage medium. Examples of technical solutions of this disclosure may be implemented as follows:

An aspect of this disclosure provides a method for displaying a virtual environment. In the method, a first virtual scene is output for display based on a first view perspective of a first virtual object in the virtual environment. The first view perspective of the first virtual object is switched to a second view perspective based on a first perspective switching operation. A field of view of the second view perspective is different from a field of view of the first view perspective. A second virtual scene is output for display based on the second view perspective of the first virtual object in the virtual environment and whether a second virtual object in the field of view of the second view perspective is in the field of view of the first view perspective. Inclusion of the second virtual object in the second virtual scene is based on whether the second virtual object is included in the field of view of the first view perspective.

An aspect of this disclosure provides an apparatus for displaying a virtual environment. The apparatus includes processing circuitry configured to output for display a first virtual scene based on a first view perspective of a first virtual object in the virtual environment. The processing circuitry is configured to switch the first view perspective of the first virtual object to a second view perspective based on a first perspective switching operation. A field of view of the second view perspective is different from a field of view of the first view perspective. The processing circuitry is configured to output for display a second virtual scene based on the second view perspective of the first virtual object in the virtual environment and whether a second virtual object in the field of view of the second view perspective is in the field of view of the first view perspective. Inclusion of the second virtual object in the second virtual scene is based on whether the second virtual object is included in the field of view of the first view perspective.

According to an aspect of this disclosure, a method for displaying a virtual world is provided, the method being performed by a first client and a second client, and the method including: displaying, by the first client, a first virtual world picture, the first virtual world picture including a picture of a virtual world observed through a first perspective of a first virtual object; switching the first perspective of the first virtual object to a second perspective in response to a first perspective switching operation, a field of view of the second perspective being different from a field of view of the first perspective; displaying a second virtual world picture, the second virtual world picture including a picture of a virtual world observed through the second perspective of the first virtual object, and virtual objects displayed in the second virtual world picture being a subset of virtual objects displayed in the first virtual world picture; and displaying, by the second client, a third virtual world picture, the third virtual world picture including a picture of a virtual world observed through a third perspective of a second virtual object, and a third virtual object located in a target space range of the virtual world being displayed in the third virtual world picture, and being not displayed in the first virtual world picture and the second virtual world picture, the target space range being an overlapping range of a field of view of the third perspective and the field of view of the second perspective, and the target space range being a non-overlapping range of the field of view of the third perspective and the field of view of the first perspective.

According to an aspect of this disclosure, a method for displaying a virtual world is provided, the method being performed by a first client, and the method including: displaying a first virtual world picture, the first virtual world picture including a picture of a virtual world observed through a first perspective of a first virtual object; switching the first perspective of the first virtual object to a second perspective in response to a first perspective switching operation, a field of view of the second perspective being different from a field of view of the first perspective; displaying a second virtual world picture, the second virtual world picture including a picture of a virtual world observed through the second perspective of the first virtual object, and in a case that a third virtual object exists within a difference set range of the field of view of the second perspective and the field of view of the first perspective, the third virtual object being invisible in the second virtual world picture.

According to an aspect of this disclosure, an apparatus for displaying a virtual world is provided, the apparatus including: a display module, configured to display a first virtual world picture, the first virtual world picture including a picture of a virtual world observed through a first perspective of a first virtual object; and a switching module, configured to switch the first perspective of the first virtual object to a second perspective in response to a first perspective switching operation, a field of view of the second perspective being different from a field of view of the first perspective; the display module being further configured to display a second virtual world picture, the second virtual world picture including a picture of a virtual world observed through the second perspective of the first virtual object, and in a case that a third virtual object exists within a difference set range of the field of view of the second perspective and the field of view of the first perspective, the third virtual object being invisible in the second virtual world picture.

According to another aspect of this disclosure, a computer device is provided, the computer device including a processor and a memory, the memory having a computer program stored therein, the computer program being loaded and executed by the processor to implement any of the methods for displaying a virtual world described herein.

An aspect of this disclosure provides a non-transitory computer-readable storage medium storing instructions which when executed by a processor cause the processor to perform any of the methods described herein.

According to another aspect of this disclosure, a computer program product is provided, having a computer program stored therein, the computer program being loaded and executed by a processor to implement any of the methods for displaying a virtual world described herein.

According to another aspect of this disclosure, a chip is provided, including a programmable logic circuit and/or a program instruction, a computer device having the chip installed therein being configured to implement any of the methods for displaying a virtual world described herein.

The technical solutions provided in the aspects of this disclosure have at least the following beneficial effects.

Switching of the perspective for observing the virtual world is supported. After the perspective is switched, even if the third virtual object exists in the difference set range between the field of view of the second perspective and the field of view of the first perspective, the third virtual object is invisible in the second virtual world picture, which helps resolve adverse impact caused by the perspective switching or the perspective change, avoids presenting information that the user is not to receive to the user, and ensures that the user does not observe, through the second perspective, the virtual object that cannot be observed from the first perspective.

### BRIEF DESCRIPTION OF THE DRAWINGS

FIG. 1 is a schematic diagram showing a virtual world according to an aspect of this disclosure.

FIG. 2 is a schematic diagram showing a virtual world according to an aspect of this disclosure.

FIG. 3 is a structural block diagram of a computer system according to an aspect of this disclosure.

FIG. 4 is a schematic flowchart of a method for displaying a virtual world according to an aspect of this disclosure.

FIG. 5 is a schematic flowchart of a method for displaying a virtual world according to an aspect of this disclosure.

FIG. 6 is a schematic diagram of a camera model according to an aspect of this disclosure.

FIG. 7 is a schematic diagram of a type of a virtual object according to an aspect of this disclosure.

FIG. 8 is a schematic diagram of a type of a virtual object according to an aspect of this disclosure.

FIG. 9 is a schematic diagram showing a virtual world according to an aspect of this disclosure.

FIG. 10 is a schematic diagram showing a virtual world according to an aspect of this disclosure.

FIG. 11 is a schematic diagram showing a virtual world according to an aspect of this disclosure.

FIG. 12 is a schematic diagram showing a virtual world according to an aspect of this disclosure.

FIG. 13 is a schematic diagram showing a virtual world according to an aspect of this disclosure.

FIG. 14 is a schematic flowchart of a method for displaying a virtual world according to an aspect of this disclosure.

FIG. 15 is a schematic diagram showing a virtual world according to an aspect of this disclosure.

FIG. 16 is a schematic diagram showing a virtual world according to an aspect of this disclosure.

FIG. 17 is a schematic diagram showing a virtual world according to an aspect of this disclosure.

FIG. 18 is a structural schematic diagram of an apparatus for displaying a virtual world according to an aspect of this disclosure.

FIG. 19 is a structural block diagram of a terminal according to an aspect of this disclosure.

FIG. 20 is a structural block diagram of a server according to an aspect of this disclosure.

### DETAILED DESCRIPTION

Examples of terms involved in the aspects of the disclosure are briefly introduced. The descriptions of the terms are provided as examples only and are not intended to limit the scope of the disclosure.

A virtual world is a virtual world displayed or provided when a client of an application runs on a terminal. The application includes, but is not limited to, a game application, an extended reality (XR) application, a social application, an interactive entertainment application, a metaverse application, and the like. The virtual world may be a simulated environment of a real world, or may be a semi-simulated and semi-fictional environment, or may be an entirely fictional environment. The virtual world may be any one of a two-dimensional (2D) virtual world, a 2.5-dimensional (2.5D) virtual world, or a three-dimensional (3D) virtual world, which is not limited in the aspects of this disclosure. A description is made by using an example in which the virtual world is the 3D virtual world in the following aspects.

A virtual object is a movable object in the virtual world. The movable object may be a virtual person, a virtual animal, an animation person, and the like, for example, a person, an animal, a plant, an oil barrel, a wall, or a stone displayed in the 3D virtual world. In some aspects, the virtual object is a 3D model created based on a skeletal animation technology. Each virtual object has its own shape and volume in the 3D virtual world, and occupies some space in the 3D virtual world.

A user interface (UI) control refers to any visible control or element that can be seen on a UI of an application, for example, an image, an input box, a text box, a button, and a label. Some of the UI controls respond to an operation of the user. For example, the user triggers a perspective switching control corresponding to perspective switching, to change a perspective configured for observing the virtual world. For example, the UI control further includes a control that cannot be seen on the UI of the application but can respond to the operation of the user. For example, a position exists on the UI. When the user clicks/taps the position, a perspective configured for observing the virtual world may be changed. The UI controls involved in the aspects of this disclosure include, but are not limited to at least one of a performance control, a perspective switching control, or a position replacement control.

The method provided in this disclosure can be applied to an application supporting the virtual world. For example, the application supporting the virtual world is an application in which the user may control the virtual object to move in the virtual world. For example, the method provided in this disclosure can be applied to any one of a virtual reality (VR) application, an augmented reality (AR) application, a social application, an interactive entertainment application, a metaverse application, a 3D map program, a VR game, an AR game, a shooting game (STG), a first-person shooting game (FPS), a third-person shooting game (TPS), a fight technology game (FTG), an action game (ACT), a multiplayer online battle arena (MOBA) game, a real-time strategy (RTS) game, a massive/massively multiplayer online game (MMOG), and an arcade game. The following aspect is described by using an application in a game as an example.

In some aspects, the foregoing applications may be applications such as a shooting game, a racing game, a role-playing game, an adventure game, a sandbox game, and a tactical arena game. The client supports at least one of a Windows operating system, an Apple Macintosh operating system, an Android operating system, an IOS operating system, and a LINUX operating system, and clients of different operating systems may be interconnected. In some aspects, the foregoing client is an application adapted to a mobile terminal having a touchscreen.

In some aspects, the foregoing client is an application developed based on a 3D engine. For example, the 3D engine is a Unity engine.

When controlling an activity of the virtual object in the virtual world, the user may switch a perspective for observing the virtual world, for example, switch from a first-person perspective to a third-person perspective. Alternatively, the perspective configured for viewing the virtual world is changed, for example, changed from a relatively small field of view to a relatively large field of view. The field of view is a range that can be observed by a user from a certain perspective. The field of view from a certain perspective may be represented through at least one of a range size and display content.

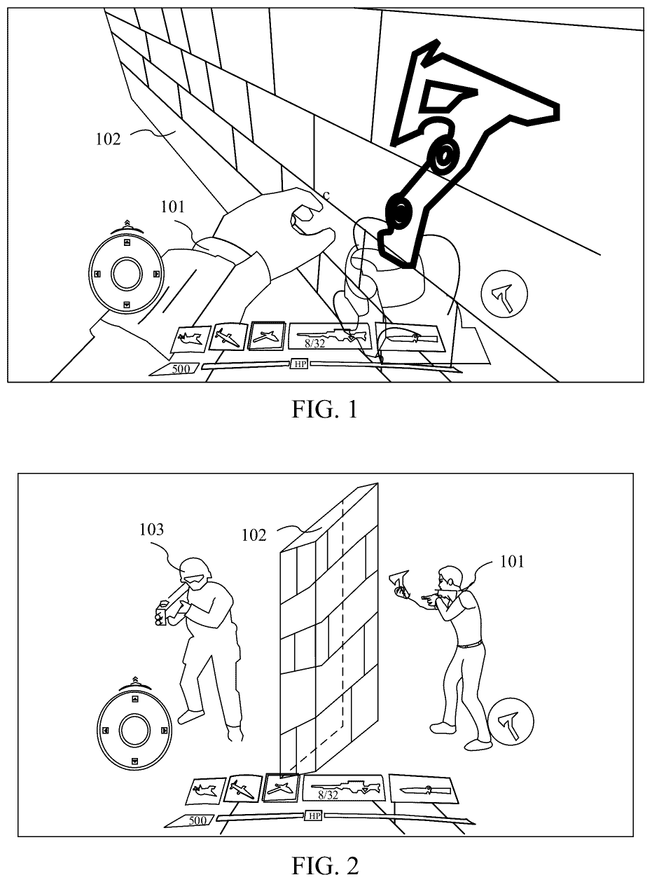

As shown in FIG. 1, a user A controls a virtual object 101 to perform an activity in a virtual world through a first-person perspective. Blocked by a virtual wall 102, except for the virtual object 101, no other virtual objects are displayed on a UI.

As shown in FIG. 2, a user A switches a first-person perspective to a third-person perspective. In this case, a virtual object 103 is displayed on a back surface of a wall 102 on a UI. In other words, after the perspectives are switched, the user A can see, through the third-person perspective, an object or a virtual object that cannot be seen from the first-person perspective.

This phenomenon seriously affects balance of the foregoing applications such as a game, a VR, an AR, and an interactive entertainment. Consequently, the user receives, through a perspective switching or a perspective change, additional information that is not to be received, seriously affecting user experience.

Based on the foregoing problem, this disclosure provides a method for displaying a virtual world, to help resolve adverse impact caused by the perspective switching or the perspective change, and avoid presenting information that the user is not to receive to the user.

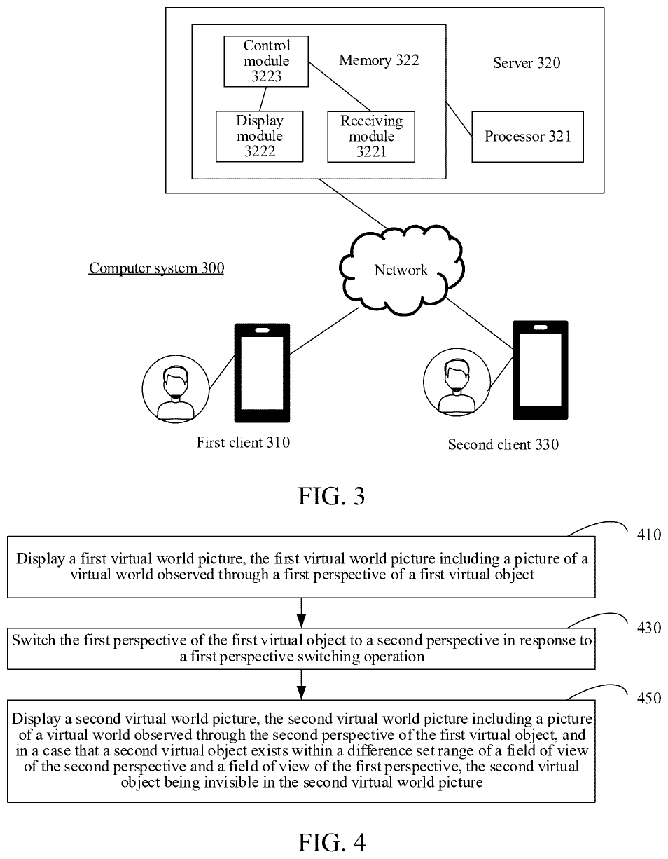

FIG. 3 is a structural block diagram of a computer system according to an aspect of this disclosure. The computer system 300 includes at least one of a first client 310, a server 320, or a second client 330.

The first client 310 has an application supporting display of a virtual world installed and running therein, for example, a game application, an XR application, a virtual social application, an interactive entertainment application, and a metaverse application. The first client 310 is a terminal used by a first user.

In some aspects, the first client 310 may be considered as a first user who uses the first client 310.

The first client 310 is connected to the server 320 through a wireless network or a wired network.

The server 320 includes one of one server, a plurality of servers, a cloud computing platform, and a virtualization center. For example, the server 320 includes a processor 321 and a memory 322. The memory 322 further includes a receiving module 3221, a display module 3222, and a control module 3223. The server 320 is configured to provide a background service for an application supporting a virtual world. In some aspects, the server 320 is in charge of primary computing, and the first client 310 and the second client 330 are in charge of secondary computing. Alternatively, the server 320 is in charge of secondary computing, and the first client 310 and the second client 330 are in charge of primary computing. Alternatively, the server 320, the first client 310, and the second client 330 perform collaborative computing through a distributed computing architecture.

The application supporting the virtual world is installed and run on the second client 330. The second client 330 is a terminal used by a second user.

In some aspects, the second client 330 may be considered as a second user who uses the second client 330.

In some aspects, only the first user exists in a current field of view. Alternatively, only the second user exists in the current field of view. Alternatively, only the first user exists in a current battle. Alternatively, only the second user exists in the current battle. Alternatively, only the first user exists in a current battlefield. Alternatively, only the second user exists in the current battlefield.

In some aspects, the first user and the second user may or may not be in the same field of view. Alternatively, the first user and the second user may or may not be in the same battle. Alternatively, the first user and the second user may or may not be on the same battlefield. In some aspects, the first user and the second user may belong to the same team, the same organization, have a friend relationship, or have temporary communication permission.

In some aspects, the application installed on the first client 310 is same as the application installed on the second client 330, or the applications installed on the two clients are the same type of applications on different control system platforms. The first client 310 may refer to one client of a plurality of clients, and the second client 330 may refer to one client of a plurality of clients. In this aspect, only the first client 310 and the second client 330 are used as an example for description. The first client 310 and the second client 330 are of the same device type or different device types. The device type includes but is not limited to at least one of a smartphone, a tablet computer, an e-book reader, a laptop portable computer, a desktop computer, a television, an AR terminal, a VR terminal, a mediated reality (MR) terminal, an XR terminal, a baffle reality (BR) terminal, a cinematic reality (CR) terminal, or a deceive reality (DR) terminal. In the following aspect, an example in which the terminal includes the smartphone is used for description.

A person skilled in the art may understand that more or fewer clients or users may be provided. For example, only one client or user, or dozens or hundreds of clients or users, or a larger quantity of clients or users may be provided. In the aspect of this disclosure, a quantity of clients or users and a device type are not limited.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

FIG. 4 is a schematic flowchart of a method for displaying a virtual world according to an aspect of this disclosure. This aspect is described by using an example in which the method is performed by the first client 310 and/or the server 320 and/or the second client 330 shown in FIG. 3. The method includes at least some of the following operations.

Operation 410: Display a first virtual world picture, the first virtual world picture including a picture of a virtual world observed through a first perspective of a first virtual object. For example, a first virtual scene is output for display based on a first view perspective of a first virtual object in the virtual environment.

A UI is displayed on a client. The UI is an interface of an application displayed on the client. For example, the UI includes a first virtual world picture and a UI control located in the first virtual world picture.

The first virtual object is a virtual object controlled by a first user. The first virtual object may be a virtual person, a virtual animal, an animation person, a simulated person, and the like, for example, a person, an animal, a plant, an oil barrel, a wall, or a stone displayed in the 3D virtual world.

The first virtual object can perform activities in the virtual world, including but not limited to at least one of adjusting a body posture, crawling, walking, running, riding, jumping, driving, shooting, throwing, performing, attacking another virtual object, attacking another virtual object through a virtual prop, or attacking another virtual object through a virtual prop.

Operation 430: Switch the first perspective of the first virtual object to a second perspective in response to a first perspective switching operation. For example, the first view perspective of the first virtual object is switched to a second view perspective based on a first perspective switching operation. A field of view of the second view perspective is different from a field of view of the first view perspective.

The perspective refers to an angle when observing the virtual world. The field of view is a range that can be observed by a user from a certain perspective. For example, the field of view from a certain perspective may be represented through at least one of a range size and display content.

The field of view of the second perspective is different from the field of view of the first perspective. In some aspects, that the field of views are different may be that sizes of the field of views are different, and all or some of display content in the field of views is different.

The perspective switching refers to switching a perspective for observing the virtual world. In some aspects, the perspective for observing the virtual world includes at least one of the first perspective or the second perspective.

For example, the first perspective includes a first-person perspective, and the second perspective includes a third-person perspective. Alternatively, the field of view of the first perspective is a subset of field of views of the second perspective. For example, the field of view of the first perspective includes display content A and display content B, and the field of view of the second perspective includes display content A, display content B, display content C, and display content D. Alternatively, the field of view of the second perspective includes the field of view of the first perspective. For example, the field of view of the second perspective is a circular range that uses a virtual article as a center and 10 centimeters as a radius, and the field of view of the first perspective is a circular range that uses the virtual article as a center and 7 centimeters as a radius.

The first perspective switching operation is configured for switching the first perspective of the first virtual object to the second perspective. For example, the first perspective switching operation includes at least one of a touch operation, a gesture operation, a button operation, a clicking/tapping operation, a sliding operation, a dragging operation, and the like. The clicking/tapping operation includes, but is not limited to, clicking/tapping forms such as a click and a double click, and the pressing operation includes, but is not limited to, pressing forms such as a short press and a long press.

The first perspective of the first virtual object is switched to the second perspective. In other words, the perspective at which the first user observes the virtual world is switched from the first perspective of the first virtual object to the second perspective.

Operation 450: Display a second virtual world picture, the second virtual world picture including a picture of a virtual world observed through the second perspective of the first virtual object, and in a case that a third virtual object exists in a difference set range of the field of view of the second perspective and the field of view of the first perspective, the third virtual object being invisible in the second virtual world picture. For example, a second virtual scene is output for display based on the second view perspective of the first virtual object in the virtual environment and whether a second virtual object in the field of view of the second view perspective is in the field of view of the first view perspective. Inclusion of the second virtual object in the second virtual scene is based on whether the second virtual object is included in the field of view of the first view perspective.

In response to the first perspective switching operation, a UI is displayed. The UI includes a second virtual world picture and a UI control located on the second virtual world picture.

The third virtual object is a virtual object controlled by a second user. The third virtual object may be a virtual person, a virtual animal, an animation person, a simulated person, and the like, for example, a person, an animal, a plant, an oil barrel, a wall, or a stone displayed in the 3D virtual world.

The third virtual object can perform activities in the virtual world, including but not limited to at least one of adjusting a body posture, crawling, walking, running, riding, jumping, driving, shooting, throwing, performing, attacking another virtual object, attacking another virtual object through a virtual prop, or attacking another virtual object through a virtual prop.

Because the field of view of the second perspective is different from the field of view of the first perspective, a difference set range exists between the field of view of the second perspective and the field of view of the first perspective. Specifically, the difference set range is a range formed by different parts between the field of view of the second perspective and the field of view of the first perspective. For example, the field of view of the first perspective includes display content A and display content B, and the field of view of the second perspective includes display content A, display content B, display content C, and display content D. Therefore, the difference set range between the field of view of the second perspective and the field of view of the first perspective is a range corresponding to the display content C and the display content D. For another example, the field of view of the second perspective is a circular range that uses a virtual article as a center and 10 centimeters as a radius, and the field of view of the first perspective is a circular range that uses the virtual article as a center and 7 centimeters as a radius. Therefore, the difference set range between the field of view of the second perspective and the field of view of the first perspective is a range formed by different parts between the two circular ranges of different sizes. In a case that the third virtual object exists in this difference set range, the third virtual object is not visible in the second virtual world picture.

In other words, although the third virtual object exists in the difference set range between the field of view of the second perspective and the field of view of the first perspective, the third virtual object cannot be observed in the second virtual world picture. Alternatively, although the third virtual object exists in the difference set range between the field of view of the second perspective and the field of view of the first perspective, the third virtual object is not displayed in the second virtual world picture. Alternatively, although the third virtual object exists in the difference set range between the field of view of the second perspective and the field of view of the first perspective, the first virtual object or the first user cannot see the third virtual object from the second perspective of the first virtual object.

The foregoing aspects of operation 410, operation 430, and operation 450 are described for a picture displayed by the first client. Based on the foregoing aspects, for the second client, a third virtual world picture is further displayed in the second client. The third virtual world picture includes a picture of the virtual world observed through the third perspective of the second virtual object. The third virtual object located in the target space range of the virtual world is displayed in the third virtual world picture, and is not displayed in the first virtual world picture and the second virtual world picture. The target space range is an overlapping range of a field of view of the third perspective and the field of view of the second perspective, and the target space range is a non-overlapping range of the field of view of the third perspective and the field of view of the first perspective.

Based on the above, according to the method provided in this aspect, switching of the perspective for observing the virtual world is supported. After the perspective is switched, even if the third virtual object exists in the difference set range between the field of view of the second perspective and the field of view of the first perspective, the third virtual object is invisible in the second virtual world picture, which helps resolve adverse impact caused by the perspective switching or the perspective change, avoids presenting information that the user is not to receive to the user, and ensures that the user does not observe, through the second perspective, the virtual object that cannot be observed from the first perspective.

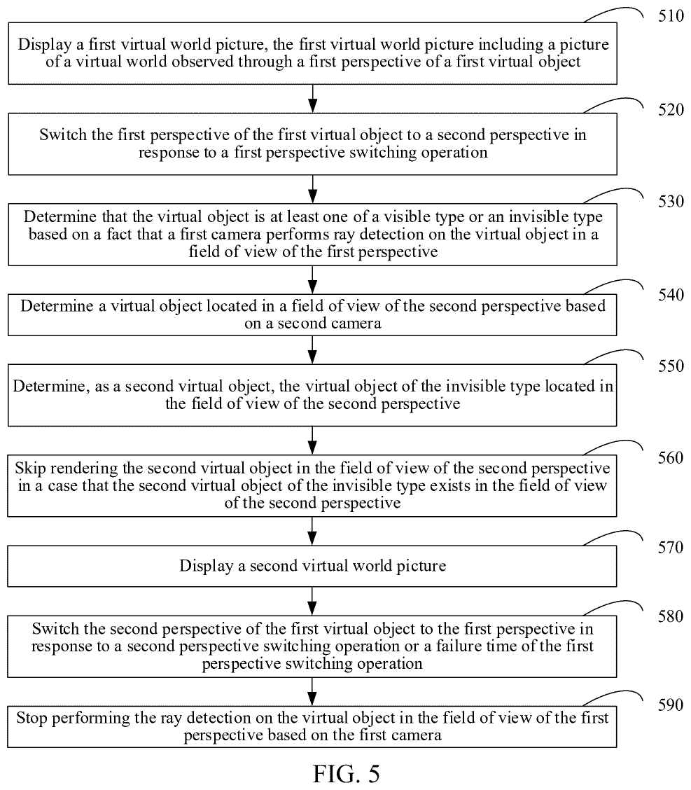

In some aspects, operation 410 may be implemented as operation 510, operation 430 may be implemented as operation 520, and operation 450 may be implemented as operation 530, operation 540, operation 550, operation 560, and operation 570. FIG. 5 is a schematic flowchart of a method for displaying a virtual world according to an aspect of this disclosure. This aspect is described by using an example in which the method is performed by the first client 310 and/or the server 320 and/or the second client 330 shown in FIG. 3. The method includes at least some of the following operations.

Operation 510: Display a first virtual world picture, the first virtual world picture including a picture of a virtual world observed through a first perspective of a first virtual object. For example, a first virtual scene is output for display based on a first view perspective of a first virtual object in the virtual environment.

A UI is displayed on a client. The UI is an interface of an application displayed on the client. For example, the UI includes a first virtual world picture and a UI control located in the first virtual world picture.

The first virtual object is a virtual object controlled by a first user.

In this aspect of this disclosure, the virtual object may be a virtual person, a virtual animal, an animation person, a simulated person, and the like, for example, a person, an animal, a plant, an oil barrel, a wall, or a stone displayed in the 3D virtual world. Different virtual objects may have the same form or different forms, and different virtual objects may have the same appearance or different appearances.

The virtual object can perform activities in the virtual world, including but not limited to at least one of adjusting a body posture, crawling, walking, running, riding, jumping, driving, shooting, throwing, performing, attacking another virtual object, attacking another virtual object through a virtual prop, or attacking another virtual object through a virtual prop.

Operation 520: Switch the first perspective of the first virtual object to a second perspective in response to a first perspective switching operation. For example, the first view perspective of the first virtual object is switched to a second view perspective based on a first perspective switching operation. A field of view of the second view perspective is different from a field of view of the first view perspective.

The field of view of the second perspective is different from the field of view of the first perspective. In some aspects, that the field of views are different may be that sizes of the field of views are different, and all or some of display content in the field of views is different.

In this aspect of this disclosure, the perspective is to an angle when observing the virtual world through a camera model. The perspective switching refers to switching a perspective for observing the virtual world. In some aspects, the camera model may be referred to as a camera for short.

The first perspective of the first virtual object is bound to a first camera. In other words, the first perspective of the first virtual object is a perspective when the first camera observes the virtual world. The second perspective of the first virtual object is bound to a second camera. In other words, the second perspective of the first virtual object is a perspective when the second camera observes the virtual world. The first camera may be referred to as a first camera model, and the second camera may also be referred to as a second camera model.

The perspective is described below by using the virtual object as an example. In some aspects, the camera model automatically follows the virtual object in the virtual world. In other words, when a position of the virtual object in the virtual world changes, a position of the camera model simultaneously changes along with the position of the virtual object in the virtual world, and the camera model is always within a preset distance range of the virtual object in the virtual world. In some aspects, in the automatic following process, relative positions of the camera model and the virtual object remain unchanged.

The camera model is a 3D model located around the virtual object in the virtual world. When a first-person perspective is used, the camera model may be located near a head of the virtual object, located at a head of the virtual object, or located at an eye portion of the virtual object.

In some aspects, when the first-person perspective is used, a viewing direction of the camera model is the same as a viewing direction of the eye portion.

When a third-person perspective is used, the camera model may be located behind the virtual object and bound to the virtual object. Alternatively, the camera model is located at any position away from the virtual object by a preset distance. The virtual object located in the virtual world may be observed from different angles through the camera model. For example, the camera model is located at a left side of the virtual object and is at a preset distance from the virtual object. For another example, the camera model is located at a right side of the virtual object and is at a preset distance from the virtual object. For another example, the camera model is located at a left front of the virtual object and is at a preset distance from the virtual object. For another example, the camera model is located at a right rear of the virtual object and is at a preset distance from the virtual object. In some aspects, when the third-person perspective is an over-the-shoulder perspective of the virtual object, the camera model is located behind the virtual object and is at a preset distance from the virtual object. For example, the camera model is positioned at a head/shoulder of the virtual object. In some aspects, when the third-person perspective is a top-down perspective of the virtual object, the camera model may be located above the head of the virtual object and at a preset distance from the virtual object. For example, the camera model is located at a top left or a top right of the virtual object. The top-down perspective is a perspective of viewing the virtual world from a perspective of top-view in air.

In some aspects, when the third-person perspective is used, the camera model is located around the virtual object, and the virtual object keeps in a center of a field of view of the camera model.

In some aspects, a viewing direction of the camera model bound to the third-person perspective is consistent with a viewing direction of the camera model bound to the first-person perspective.

In some aspects, the camera model is not actually displayed in the virtual world. In other words, the camera model is not displayed in the virtual world displayed in the UI.

A description is made by using an example in which the camera model is located at any position from the virtual object by a preset distance. In some aspects, each perspective corresponds to one camera model, or each perspective is bound to one camera model. The camera model may rotate with the virtual object as a rotation center. For example, the camera model rotates with any point of the virtual object as the rotation center. During rotation, the camera model not only rotates in angle, but also deviates in displacement. A distance between the camera model and the rotation center remains unchanged during rotation. In other words, the camera model rotates on a surface of a sphere with the rotation center as the center of the sphere. Any point of the virtual object may be a head or a torso of the virtual object, or any point around the virtual object, which is not limited in this aspect of this disclosure. In some aspects, when the camera model observes the virtual world, the center of the perspective of the camera model is directed at a direction in which the point on the spherical surface where the camera model is located is directed at the center of the sphere.

In some aspects, the camera model may further observe the virtual object at a preset angle in different directions of the virtual object.

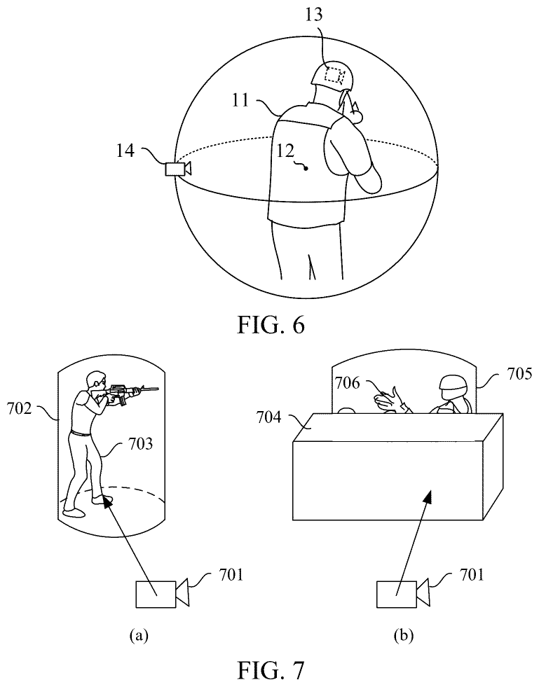

For example, referring to FIG. 6, a point is determined as a rotation center 12 in a virtual object 11. The camera model may rotate around the rotation center 12. When the camera model rotates around the rotation center 12, a perspective direction of the camera model also changes as the camera model rotates. In some aspects, the first perspective of the virtual object 11 is bound to the first camera, and the first camera is configured with an initial position. For example, the initial position is a position of the head of the virtual object, to be specific, a position 13. For example, a perspective switching operation is performed, to switch the first perspective of the virtual object 11 to the second perspective. The second perspective is bound to the second camera, and the second camera is also configured with an initial position. For example, the initial position is a position 14. Therefore, after the perspective switching operation is performed, the camera model observing the virtual world is switched from the first camera to the second camera, and the position of the camera model observing the virtual world is correspondingly switched from the position 13 to the position 14.

In some aspects, the first perspective of the first virtual object includes a first-person perspective of the first virtual object, and the second perspective of the first virtual object includes a third-person perspective of the first virtual object.

In some aspects, the field of view of the first perspective of the first virtual object is a subset of the field of view of the second perspective of the first virtual object. For example, the field of view of the first perspective of the first virtual object includes display content A and display content B, and the field of view of the second perspective of the first virtual object includes display content A, display content B, display content C, and display content D. Alternatively, the field of view of the second perspective of the first virtual object includes the field of view of the first perspective of the first virtual object. For example, the field of view of the second perspective of the first virtual object is a circular range that uses a virtual article as a center and 10 centimeters as a radius, and the field of view of the first perspective of the first virtual object is a circular range that uses the virtual article as a center and 7 centimeters as a radius.

The first perspective switching operation is configured for switching the first perspective of the first virtual object to the second perspective. For example, the first perspective switching operation includes at least one of a touch operation, a gesture operation, a button operation, a clicking/tapping operation, a sliding operation, a dragging operation, a pressing operation, and the like. The clicking/tapping operation includes, but is not limited to, clicking/tapping forms such as a click and a double click, and the pressing operation includes, but is not limited to, pressing forms such as a short press and a long press.

The first perspective of the first virtual object is switched to the second perspective. In other words, the perspective at which the first user observes the virtual world is switched from the first perspective of the first virtual object to the second perspective.

In some aspects, the first user performs at least one of the touch operation, the button operation, the clicking/tapping operation, a sliding operation, a pressing operation, and the like on the UI control, to perform the first perspective switching operation, and switch the first perspective of the first virtual object to the second perspective.

In some aspects, the first user performs at least one of the button operation on a keyboard, the clicking/tapping operation on a mouse, the sliding operation on a mouse, or the like, to perform the first perspective switching operation, and switch the first perspective of the first virtual object to the second perspective.

In some aspects, the first user performs a gesture operation, to perform the first perspective switching operation, to switch the first perspective of the first virtual object to the second perspective.

In some aspects, the first user performs at least one of the dragging operation, the sliding operation, the clicking/tapping operation, the pressing operation, and the like on the UI, to perform the first perspective switching operation, and switch the first perspective of the first virtual object to the second perspective.

In some aspects, the UI control is a perspective switching control, and is dedicated to a perspective switching operation. For example, the UI control is configured to switch from the first perspective to the second perspective, and/or, configured to switch from the second perspective to the first perspective.

In some aspects, the UI control is a function control related to perspective switching. For example, the UI control itself is configured for functions such as a performance or an action demonstration. After a user performs an operation on the UI control, perspective switching is automatically performed.

For example, the UI control is a performance control. After a user performs the touch operation on the UI control, the UI displays an action list, and the action list includes one or more performable actions that can be selected by the user, for example, dancing, clapping, making a heart-shaped finger action, bowing, and drawing fire. The action list displays the performable action in at least one form of text, pattern, animation, and the like. The first user performs the sliding operation or the touch operation on the action list, and selects the performance action “dancing”. The perspective at which the first user observes the virtual world is automatically switched from the first perspective to the second perspective. From the second perspective, the first user may observe that the virtual object is “dancing”. In some aspects, after the “dancing” ends, the perspective at which the first user observes the virtual world is automatically switched from the second perspective back to the first perspective. The first perspective is a default perspective in a game. For example, when the virtual object is in a fight state, a running state, a crawling state, or a static state, the perspective at which the first user observes the virtual world is the first perspective by default. The second perspective is a selectable perspective or a non-default perspective in the game. For example, when the virtual object is in a performing state, the perspective at which the first user observes the virtual world is the second perspective.

Operation 530: Determine that the virtual object is at least one of the visible type or the invisible type based on a fact that the first camera performs ray detection on the virtual object in the field of view of the first perspective. For example, ray detection is performed based on the first virtual camera to the second virtual object in the field of view of the first view perspective. The second virtual object is classified as a visible type or an invisible type based on the ray detection.

The ray detection is a detection manner of transmitting a ray from a central point of a camera to a virtual object, and is used for determining whether the virtual object is the visible type or the invisible type. In this aspect, the ray detection is a detection manner of transmitting the ray from the central point of the first camera to the virtual object in the field of view of the first perspective.

In some aspects, emitting a ray from a central point of the first camera to the virtual object in the field of view of the first perspective; determining, as the visible type, a virtual object corresponding to a collider model that intersects with the ray; and determining, as the invisible type, a virtual object corresponding to a collider model that does not intersect with the ray, the virtual object being located inside the collider model.

In some aspects, the virtual object corresponding to a collider model that intersects with the ray is marked as the visible type, and the virtual object corresponding to a collider model that does not intersect with the ray is marked as the invisible type. Alternatively, the virtual object corresponding to a collider model that intersects with the ray is marked; and the virtual object corresponding to a collider model that does not intersect with the ray is not marked.

The collider model is invisible in the virtual world. Each virtual object has a collider model in a one-to-one correspondence. The collider model is larger than a virtual object body, the collider model is located at a periphery of a virtual object body, and the virtual object body is located inside the collider model. For example, the collider model is a 3D cylinder. The 3D cylinder is located at the periphery of the virtual object body, and the virtual object body is located inside the 3D cylinder model.

Because the collider model is larger than the virtual object body, compared with performing the ray detection on the virtual object entity, performing the ray detection on the collider model has higher accuracy, which helps reduce a probability of an erroneous determination.

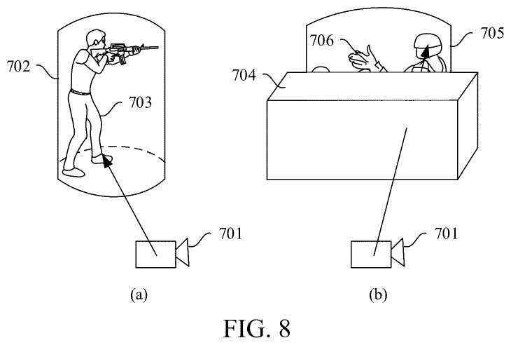

In some aspects, the ray is blocked by a virtual object or an object in the virtual scene. In other words, it may be considered that the ray cannot penetrate the virtual object or the object in the virtual scene. That the collider model intersects with the ray the ray means that the ray is not blocked and directly injects onto the collider model. For example, as shown in FIG. 7(a), a ray transmitted from a central point of a camera 701 is not blocked and directly injects onto a collider model 702, a virtual object 703 exists inside the collider model 702, and the collider model 702 is a frame structure around the virtual object 703. Therefore, the virtual object 703 is determined as a visible type. Relatively, that the collider model does not intersect with the ray means that the ray is blocked and cannot directly shoot the collider model. For example, as shown in FIG. 7(b), a ray transmitted from a central point of a camera 701 is blocked by a virtual object 704 and cannot directly inject onto a collider model 705, a virtual object 706 exists inside the collider model 705, and the collider model 705 is a box structure around the virtual object 706. Therefore, the virtual object 706 is determined as an invisible type.

In some aspects, the ray is not blocked by the virtual object or the object in the virtual scene. In other words, it may be considered that the ray can penetrate the virtual object or the object in the virtual scene. That the collider model intersects with the ray means that no other virtual object or object exists in a part of the ray from a starting point of the ray to the collider model. For example, as shown in FIG. 8(a), a ray is transmitted from a central point of a camera 701, no other virtual object or object exists in a part of the ray from the central point of the camera 701 to a collider model 702, a virtual object 703 exists inside the collider model 702, and the collider model 702 is a frame structure around the virtual object 703. Therefore, the virtual object 703 is determined as a visible type. Relatively, that the collider model does not intersect with the ray means that another virtual object or object exists in a part of the ray from a starting point of the ray to the collider model. For example, as shown in FIG. 8(b), a ray is transmitted from a central point of a camera 701, a virtual object 704 exists in a part of the ray from the central point of the camera 701 to a collider model 705, a virtual object 706 exists inside the collider model 705, and the collider model 705 is a frame structure around the virtual object 706. Therefore, the virtual object 706 is determined as an invisible type.

The camera 701, the collider model 702, and the collider model 705 in FIG. 7 and FIG. 8 are actually invisible. In other words, the camera model and the collider model around the virtual object are not displayed on the UI.

Operation 540: Determine a virtual object located in the field of view of the second perspective based on the second camera. For example, based on the second virtual camera, whether the second virtual object is located in the field of view of the second view perspective is determined.

The virtual world is observed through the second camera, and the second camera is bound to the second perspective of the first virtual object. It is determined, based on the second camera, whether there is any virtual object in the field of view of the second perspective. If the virtual object exists in the field of view of the second perspective, a quantity, a posture, a position, a type, and the like of the virtual object existing in the field of view of the second perspective are further determined. The type of the virtual object includes the visible type and/or the invisible type.

Operation 550: Determine, as a third virtual object, the virtual object of the invisible type located in the field of view of the second perspective.

Based on that the second camera can determine the virtual object in the field of view of the second perspective, a virtual object of a type determined as the invisible type is determined as the third virtual object. In other words, the third virtual object is a virtual object that belongs to the invisible type in the field of view of the second perspective.

In some aspects, the virtual object of the visible type located in the field of view of the second perspective is determined as a fourth virtual object. In other words, the fourth virtual object is a virtual object that belongs to the visible type in the field of view of the second perspective.

The visible type and the invisible type are determined in operation 530 based on the field of view of the first perspective.

Operation 560: Skip rendering the third virtual object in the field of view of the second perspective in a case that the third virtual object of an invisible type exists in the field of view of the second perspective, to obtain the second virtual world picture.

Rendering refers to a process of calculating and combining elements such as a model, a light source, a material, a texture, and a camera in a 3D virtual world, to generate a 2D image. In this aspect, virtual scenes in field of views of different perspectives may be obtained through rendering.

When the virtual scene in the field of view of the second perspective is rendered, if the third virtual object of the invisible type exists in the field of view of the second perspective, the third virtual object in the field of view of the second perspective is not rendered, to obtain the second virtual world picture. The operation may also be understood as: shielding the third virtual object in the field of view of the second perspective, so that the third virtual object is not displayed in the second virtual world picture.

In some aspects, in a case that the fourth virtual object of the visible type exists in the field of view of the second perspective, the fourth virtual object of the visible type in the field of view of the second perspective is rendered. In other words, when the virtual scene in the field of view of the second perspective is rendered, if the fourth virtual object of the visible type exists in the field of view of the second perspective, the fourth virtual object in the field of view of the second perspective is rendered, to obtain the second virtual world picture.

In some aspects, the third virtual object of the invisible type and the fourth virtual object of the visible type exist in the field of view of the second perspective. Therefore, when the virtual scene in the field of view of the second perspective is rendered, the third virtual object in the field of view of the second perspective is not rendered, and the fourth virtual object in the field of view of the second perspective is rendered, to obtain the second virtual world picture.

Operation 570: Display the second virtual world picture,
the second virtual world picture including a picture of a virtual world observed through the second perspective of the first virtual object. For example, a second virtual scene is output for display based on the second view perspective of the first virtual object in the virtual environment and whether a second virtual object in the field of view of the second view perspective is in the field of view of the first view perspective. Inclusion of the second virtual object in the second virtual scene is based on whether the second virtual object is included in the field of view of the first view perspective.

In some aspects, the second virtual world picture displays the fourth virtual object of the visible type, and/or does not display the third virtual object of the invisible type.

In some aspects, operation 530 to operation 570 are performed in real time. In other words, after the first perspective switching operation is performed, operation 530 is continuously repeated. Namely, the ray detection is dynamically performed on the virtual object in the field of view of the first perspective by the first camera in real time, to determine the virtual object as the visible type and/or the invisible type, thereby dynamically performing operation 540 to operation 570 in real time. It is ensured that the second virtual world picture is updated in real time. The virtual object in the field of view of the first perspective and the type of the virtual object can be fed back in real time.

Operation 580: Switch the second perspective of the first virtual object to the first perspective in response to a second perspective switching operation or a failure time of the first perspective switching operation. For example, the second view perspective of the first virtual object is switched to the first view perspective based on at least one of a second perspective switching operation or expiration of a validity period associated with the first perspective switching operation.

The second perspective switching operation is configured for switching the second perspective of the first virtual object to the first perspective. For example, the second perspective switching operation includes at least one of a touch operation, a gesture operation, a button operation, a clicking/tapping operation, a sliding operation, a dragging operation, a pressing operation, and the like. The clicking/tapping operation includes, but is not limited to, clicking/tapping forms such as a click and a double click, and the pressing operation includes, but is not limited to, pressing forms such as a short press and a long press.

The second perspective of the first virtual object is switched to the first perspective. In other words, the perspective at which the first user observes the virtual world is switched from the second perspective of the first virtual object to the first perspective.

In some aspects, the first user performs at least one of the touch operation, the button operation, the clicking/tapping operation, a sliding operation, a pressing operation, and the like on the UI control, to perform the second perspective switching operation, and switch the second perspective of the first virtual object to the first perspective.

In some aspects, the first user performs at least one of the button operation on a keyboard, the clicking/tapping operation on a mouse, the sliding operation on a mouse, or the like, to perform the second perspective switching operation, and switch the second perspective of the first virtual object to the first perspective.

In some aspects, the first user performs a gesture operation, to perform the second perspective switching operation, to switch the second perspective of the first virtual object to the first perspective.

In some aspects, the first user performs at least one of the dragging operation, the sliding operation, the clicking/tapping operation, the pressing operation, and the like on the UI, to perform the second perspective switching operation, and switch the second perspective of the first virtual object to the first perspective.

In some aspects, the first perspective switching operation has the failure time. In other words, if the first switching operation reaches a specific duration, the first perspective switching operation fails, and the first perspective is switched from the second perspective back to the first perspective. In some aspects, the failure time of the first perspective switching operation is preset, or autonomously determined by the first user, or the failure time of the first perspective switching operation is immediately reached in a case that a failure event is satisfied. In some aspects, the failure event includes but is not limited to at least one of the first virtual object changing a state, the first virtual object changing an action, the first virtual object being attacked, the first virtual object changing a position, or the first client exiting the application.

For example, after the first perspective switching operation is performed, the first perspective of the first virtual object is switched to the second perspective, and a preset failure time of the first perspective switching operation is 10 seconds. However, when the first perspective switching operation is performed for 5 seconds, the first virtual object is attacked, and the failure time of the first perspective switching operation is changed to 5 seconds. In other words, in a case that the first virtual object is attacked, the second perspective of the first virtual object is immediately switched back to the first perspective.

Operation 590: Stop performing the ray detection on the virtual object in the field of view of the first perspective based on the first camera.

When the second perspective of the first virtual object is switched to the first perspective, the ray detection on the virtual object in the field of view of the first perspective based on the first camera is stopped.

In other words, within the failure time of the first perspective switching operation, the ray detection is not performed based on the first camera on the virtual object in the field of view of the first perspective.

Based on the above, according to the method provided in this aspect, switching of the perspective for observing the virtual world is supported. After the perspective is switched, even if the third virtual object of the visible type exists in the field of view of the second perspective, the third virtual object is invisible in the second virtual world picture, which helps resolve adverse impact caused by the perspective switching or the perspective change, avoids presenting information that the user is not to receive to the user, and ensures that the user does not observe, through the second perspective, the virtual object that cannot be observed from the first perspective.

When functions such as a performance or an action demonstration is introduced to the game, it can be avoided that the user uses such a function to “cheat”, and the user is prevented from intentionally observing a virtual object or an object that cannot be observed by switching a perspective, thereby affecting balance of the game and user experience.

Next, operation 530 of “determining that the virtual object is a visible type or an invisible type based on that the first camera performs ray detection on the virtual object in the field of view of the first perspective” is further described.

In some aspects, considering a volume of the virtual object, and accuracy and simplicity of the ray detection, several key points are provided on the virtual object, and the ray detection is performed based on the key points of the virtual object in the field of view of the first perspective by the first camera, to determine whether the virtual object is the visible type and/or the invisible type.

In some aspects, the virtual object includes m key points. The m key points include at least two of a head key point, a left arm key point, a right arm key point, a left hand key point, a right hand key point, an abdomen key point, a left leg key point, a right leg key point, a left foot key point, a right foot key point, and a waist key point. m is a positive integer greater than or equal to 2.

In some aspects, the ray detection is performed on m key points of the virtual object in the field of view of the first perspective based on the first camera, to determine whether the virtual object is the visible type and/or the invisible type.

In some aspects, a ray is transmitted from a center of the first camera to the m key points, and the virtual object corresponding to the collider model in which at least one of the m key points intersects with the ray is determined as the visible type; and the virtual object corresponding to the collider model in which all of the m key points do not intersect with the ray is determined as the invisible type.

In some aspects, n key points are selected from the m key points based on at least one of system performance, a posture of the virtual object, a form of the virtual object, a scene type of the virtual world, and a quantity of virtual objects in the field of view of the first perspective. n is a positive integer less than or equal to M.

In some aspects, the system performance is represented through at least one of the following performance parameters: central processing unit (CPU) performance, graphics processing unit (GPU) performance, a computing speed, a storage speed, storage capacity, an operating memory, and a battery temperature.

In some aspects, in a case that the system performance is higher than or equal to a first threshold, n is equal to m. In other words, the ray detection is performed, based on the first camera, on the m key points of the virtual object in the field of view of the first perspective. In a case that the system performance is less than the first threshold, n is less than m. In other words, the ray detection is performed, based on the first camera, on the n key points of the virtual object in the field of view of the first perspective. The first threshold is preset, autonomously determined by the first user, or adjusted based on an actual technical requirement.

For example, the m key points include at least two of a head key point, a left arm key point, a right arm key point, a left hand key point, a right hand key point, an abdomen key point, a left leg key point, a right leg key point, a left foot key point, a right foot key point, and a waist key point. In a case that the system performance is less than the first threshold, the n key points are selected from the m key points. The n key points include at least one of the head key point, the left hand key point, the right hand key point, the left foot key point, and the right foot key point.

For example, in a case that the posture of the virtual object is in a standing state, the n key points are selected from the m key points. The n key points include at least one of the head key point, the left hand key point, the right hand key point, the left foot key point, and the right foot key point. In a case that the posture of the virtual object is in a prone state, the n key points are selected from the m key points. The n key points include at least one of the head key point, the left arm key point, the right arm key point, the left leg key point, the right leg key point, and the waist key point. In a case that the posture of the virtual object is in a supine state, the n key points are selected from the m key points. The n key points include at least one of the head key point, the left arm key point, the right arm key point, the left leg key point, the right leg key point, and the abdomen key point. In a case that the posture of the virtual object is in a crouching state, the n key points are selected from the m key points. The n key points include at least one of the head key point, the left arm key point, the right arm key point, the left leg key point, the right leg key point, and the waist key point.

For example, when the form of the virtual object is a human form, n is equal to m. When the form of the virtual object is in an animal form, the n key points are selected from the m key points. The n key points include at least one of the head key point, the abdomen key point, the waist key point, the left foot key point, and the right foot key point.

For example, in a case that the type of the virtual scene is a land scene, the n key points are selected from the m key points. The n key points include at least one of the head key point, the left arm key point, the right arm key point, the left hand key point, the right hand key point, the abdomen key point, the left leg key point, the right leg key point, the left foot key point, the right foot key point, and the waist key point. In a case that the type of the virtual scene is an ocean scene, the n key points are selected from the m key points. The n key points include at least one of the head key point, the left arm key point, the right arm key point, the left hand key point, the right hand key point, and the waist key point. In a case that the type of the virtual scene is a sky scene, the n key points are selected from the m key points. The n key points include at least one of the head key point, the left arm key point, the right arm key point, the left hand key point, the right hand key point, the left leg key point, the right leg key point, the left foot key point, the right foot key point, and the abdomen key point.

For example, in a case that the quantity of virtual objects in the field of view of the first perspective is greater than or equal to a second threshold, the n key points include at least one of the head key point, the left hand key point, the right hand key point, the left foot key point, and the right foot key point. In a case that the quantity of virtual objects in the field of view of the first perspective is less than the second threshold, the n key points include at least one of the head key point, the left hand key point, the right hand key point, the left foot key point, the right foot key point, the abdomen key point, and the waist key point.

In some aspects, the ray detection is performed on the n key points of the virtual object in the field of view of the first perspective based on the first camera, to determine whether the virtual object is the visible type and/or the invisible type.

In some aspects, a ray is transmitted from a center of the first camera to the n key points, and the virtual object corresponding to the collider model in which at least one of the n key points intersects with the ray is determined as the visible type; and the virtual object corresponding to the collider model in which all of the n key points do not intersect with the ray is determined as the invisible type.

The ray detection is performed on the several key points of the virtual object, which helps reduce complexity of the ray detection, improves simplicity and a speed of the ray detection, and causes a result of the ray detection to be more accurate, thereby enabling a faster interaction of the ray detection result between the client and the server and reducing delay.

Based on the system performance, the posture of the virtual object, the form of the virtual object, the type of the virtual scene, and the quantity of virtual objects in the field of view of the first perspective, the several key points are selected from the virtual object, so that flexibility of the ray detection and robustness of the method for displaying a virtual world provided in the aspects of this disclosure can be effectively improved, and an accurate ray detection result can be flexibly and rapidly obtained in various scenes, thereby improving user experience.

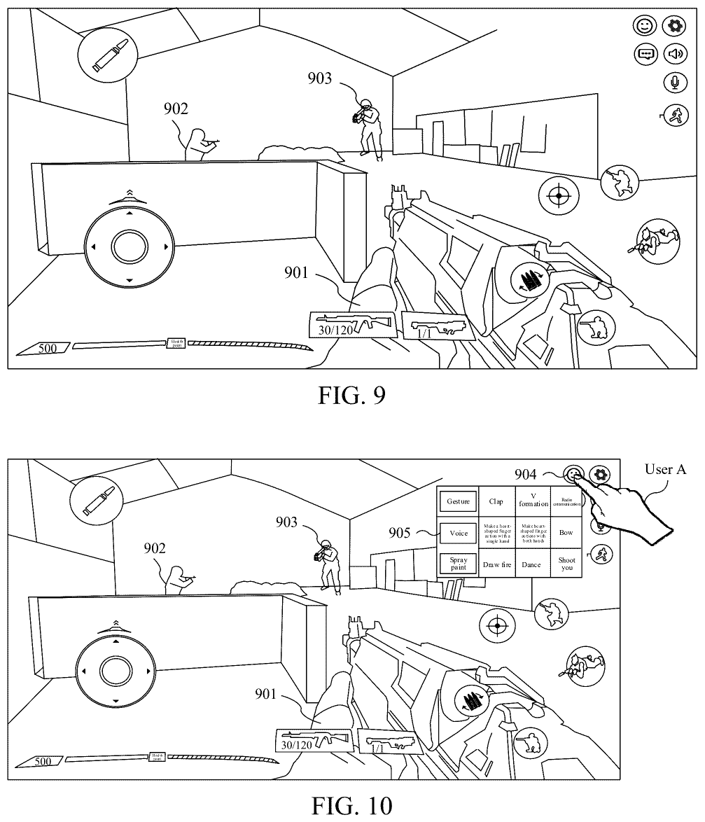

FIG. 9 to FIG. 13 are schematic diagrams showing a virtual world according to an aspect of this disclosure.

Using an example in which a first perspective is the first-person perspective, a virtual world observed by a user A through the first perspective of a virtual object 901 is shown in FIG. 9. In a first virtual world picture shown in FIG. 9, in addition to the virtual object 901, a virtual object 902 and a virtual object 903 are further displayed.

An example in which a first perspective switching operation is a touch operation on a UI control 904 is used. As shown in FIG. 10, after the user A touches the UI control 904, an interaction list 905 is displayed on a UI. The user A selects an action of “dancing” from the interaction list 905, the virtual object 901 enters a “dancing” state, and the first perspective switches to a second perspective.

An example in which the second perspective is a third-person perspective, and a camera model bound with the third-person perspective is located at a rear upper part of the virtual object 901 is used.

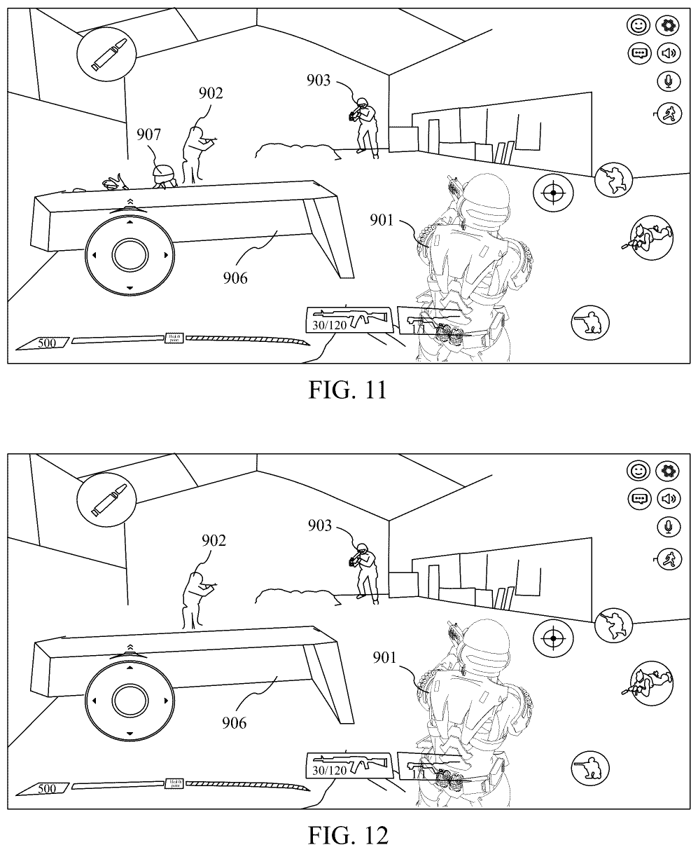

If the method for displaying a virtual world provided in the aspects of this disclosure is not used, as shown in FIG. 11, a virtual object 907 may be observed to exist behind a cover 906 from the second perspective of the virtual object 901. However, the virtual object 907 is actually invisible from the first perspective of the virtual object 901. Consequently, after the first perspective is switched to the second perspective, the user A receives information that is not to be received. The virtual object 907 exists behind the cover 906, which affects balance of the game.

If the method for displaying a virtual world provided in the aspects of this disclosure is used, as shown in FIG. 12, when the perspective of the virtual object 901 is switched to the second perspective, if it is determined that the virtual object 907 exists in the field of view of the second perspective of the virtual object 901 and the virtual object 907 is invisible in the field of view of the first perspective of the virtual object 901, the virtual object 907 is not rendered. Because the virtual object 902 and the virtual object 903 exist in the field of view of the second perspective of the virtual object 901, and the virtual object 902 and the virtual object 903 are visible in the field of view of the first perspective of the virtual object 901, the virtual object 902 and the virtual object 903 are rendered. In this way, the second virtual world picture shown in FIG. 12 is obtained. The virtual object 901, the virtual object 902, and the virtual object 903 are displayed in the second virtual world picture, and the virtual object 907 is not displayed.

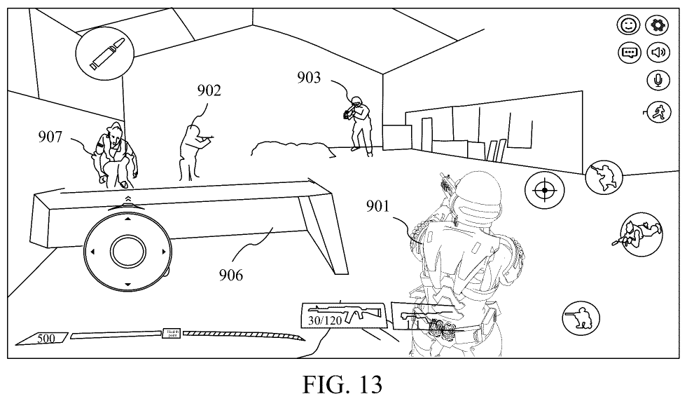

After the perspective of the virtual object 901 is switched to the second perspective, the ray detection is repeatedly performed on the virtual object in the field of view of the first perspective in real time and dynamically. When it is detected that the virtual object 907 is no longer covered by the cover 906, but is visible in the field of view of the first perspective, the virtual object 907 is rendered. As shown in FIG. 13, the second virtual world picture can dynamically display the virtual object 907 in real time. It is ensured that after the first perspective switching operation is performed, the user A can receive information that the virtual object enters or exits the field of view of the first perspective in real time.

However, after the first perspective switching operation reaches the failure time, for example, after a “dancing” state reaches a preset failure time, the second perspective is switched back to the first perspective, and the UI redisplays the first virtual world picture.

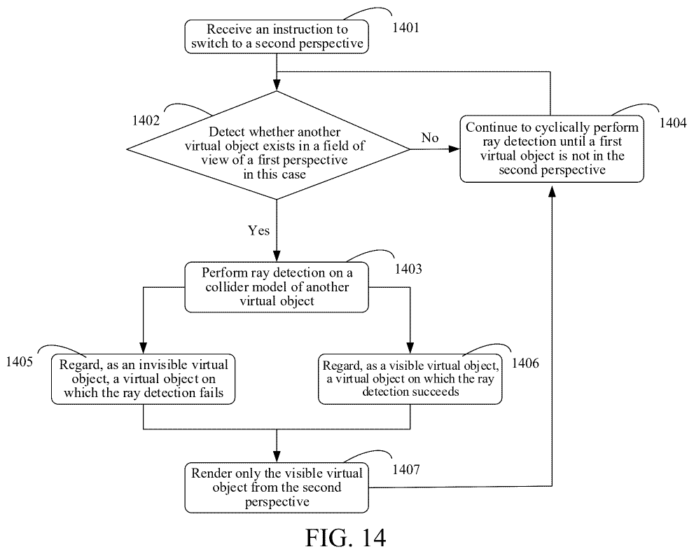

FIG. 14 is a schematic flowchart of a method for displaying a virtual world according to an aspect of this disclosure. This aspect is described by using an example in which the method is performed by the first client 310 and/or the server 320 and/or the second client 330 shown in FIG. 3. The method includes at least some of the following operations.

Operation 1401: Receive an instruction to switch to a second perspective.

The first user uses the first client 310, and observes the virtual world through a first perspective of a first virtual object.

In some aspects, the first client receives an instruction of the first user for switching the first perspective of the first virtual object to the second perspective, and the first client switches the first perspective of the first virtual object to the second perspective.

In some aspects, the first client receives an instruction of the first user for switching the first perspective of the first virtual object to the second perspective, the first client transmits the instruction to the server, the server receives the instruction for switching the first perspective of the first virtual object to the second perspective, and the server switches the first perspective of the first virtual object to the second perspective.

Operation 1402: Detect whether another virtual object exists in a field of view of the first perspective in this case.

The another virtual object refers to a virtual object other than the first virtual object.

In some aspects, the first client detects whether another virtual object exists in the field of view of the first perspective.

In some aspects, the server detects whether another virtual object exists in the field of view of the first perspective in this case.

If a detection result indicates that another virtual object exists in the field of view of the first perspective in this case, operation 1403 is performed.

If a detection result indicates that another virtual object does not exist in the field of view of the first perspective, operation 1404 is performed.

Operation 1403: Perform ray detection on a collider model of another virtual object.

For related content of operation 1403, reference is made to the foregoing content related to the ray detection. Details are not described herein again.

After operation 1403 is performed, operation 1405 and/or operation 1406 is performed.

In some aspects, operation 1403 is performed by the first client, or operation 1403 is performed by the server, or operation 1403 is performed by the first client and the server.

Operation 1405: Regard, as an invisible virtual object, a virtual object on which the ray detection fails.

The virtual object on which the ray detection fails refers to a virtual object corresponding to a collider model that does not intersect with the ray.

In some aspects, the virtual object corresponding to a collider model that does not intersect with the ray is marked as the invisible type. Alternatively, the virtual object regarded as the invisible object is not marked.

In some aspects, operation 1405 is performed by the first client, or operation 1405 is performed by the server, or operation 1405 is performed by the first client and the server.

Operation 1406: Regard, as a visible virtual object, a virtual object on which the ray detection succeeds.

The virtual object on which the ray detection succeeds refer to a virtual object corresponding to a collider model that intersects with the ray.

In some aspects, the virtual object corresponding to a collider model that intersects with the ray is marked as the visible type. Alternatively, the visible virtual object is marked.

In some aspects, operation 1406 is performed by the first client, or operation 1406 is performed by the server, or operation 1406 is performed by the first client and the server.

Operation 1407: Render only the visible virtual object from the second perspective.

In some aspects, the first client renders only the virtual object marked as the visible type and does not render the virtual object marked as the invisible type from the second perspective.

In some aspects, the first client renders only the marked virtual object (i.e., the visible virtual object) through the second perspective, and does not render the unmarked virtual object (i.e., the invisible virtual object) from the second perspective.

In some aspects, the server renders only the virtual object marked as the visible type and does not render the virtual object marked as the invisible type from the second perspective.

In some aspects, the server renders only the marked virtual object (i.e., the visible virtual object), and does not render the unmarked virtual object (i.e., the invisible virtual object) from the second perspective.

Operation 1404: Continue to cyclically perform the ray detection until the first virtual object is not in the second perspective.

In other words, during a period in which the first user uses the first client 310 to observe the virtual world through the second perspective of the first virtual object, whether another virtual object exists in the field of view of the first perspective is cyclically detected, and the ray detection is performed on the collider model of the another virtual object. During a period in which the first user uses the first client 310 to observe the virtual world through the first perspective of the first virtual object, detection of whether another virtual object exists in the field of view of the first perspective is stopped, and the ray detection is performed on the collider model of the another virtual object.

Based on the above, according to the method provided in this aspect, switching of the perspective for observing the virtual world is supported. After the perspective is switched, even if the third virtual object of the visible type exists in the field of view of the second perspective, the third virtual object is invisible in the second virtual world picture, which helps resolve adverse impact caused by the perspective switching or the perspective change, avoids presenting information that the user is not to receive to the user, and ensures that the user does not observe, through the second perspective, the virtual object that cannot be observed from the first perspective.

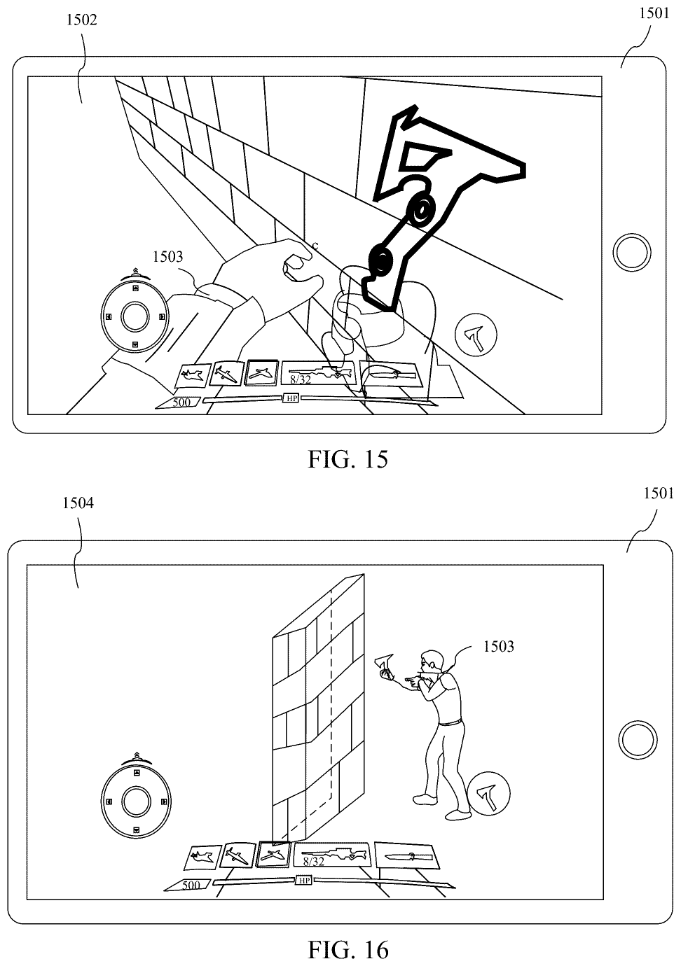

FIG. 15 to FIG. 17 are schematic diagrams of a method for displaying a virtual world according to an aspect of this disclosure.

As shown in FIG. 15, a first client 1501 displays a first virtual world picture 1502. The first virtual world picture 1502 includes a picture of a virtual world observed through a first perspective of a first virtual object 1503.

The first client 1501 switches the first perspective of the first virtual object 1503 to a second perspective in response to a first perspective switching operation, a field of view of the second perspective being different from a field of view of the first perspective. An example in which the first perspective of the first virtual object 1503 is a first-person perspective of the first virtual object 1503, and the second perspective of the first virtual object 1503 is a third-person perspective of the first virtual object 1503 is used.

As shown in FIG. 16, the first client 1501 is in response to the first perspective switching operation, and the first client 1501 displays a second virtual world picture 1504. The second virtual world picture 1504 includes a picture of a virtual world observed through a second perspective of the first virtual object 1503. In addition, virtual objects displayed in the second virtual world picture 1504 is a subset of virtual objects displayed in the first virtual world picture 1502.

In some aspects, the virtual object displayed in the second virtual world picture 1504 is the same as the virtual object displayed in the first virtual world picture 1502.

In some aspects, the virtual objects displayed in the second virtual world picture 1504 is a proper subset of the virtual objects displayed in the first virtual world picture 1502.

For example, the second virtual world picture 1504 displays only the first virtual object 1503. Alternatively, from the second perspective, only some virtual objects displayed in the first virtual world picture 1502 can be observed, and the second virtual world picture 1504 displays only some of the virtual objects displayed in the first virtual world picture 1502. Alternatively, a scope of the virtual world corresponding to the second virtual world picture 1504 is less than a scope of the virtual world corresponding to the first virtual world picture 1502, and a virtual object displayed in the second virtual world picture 1504 is a part of the virtual objects displayed in the first virtual world picture 1502.

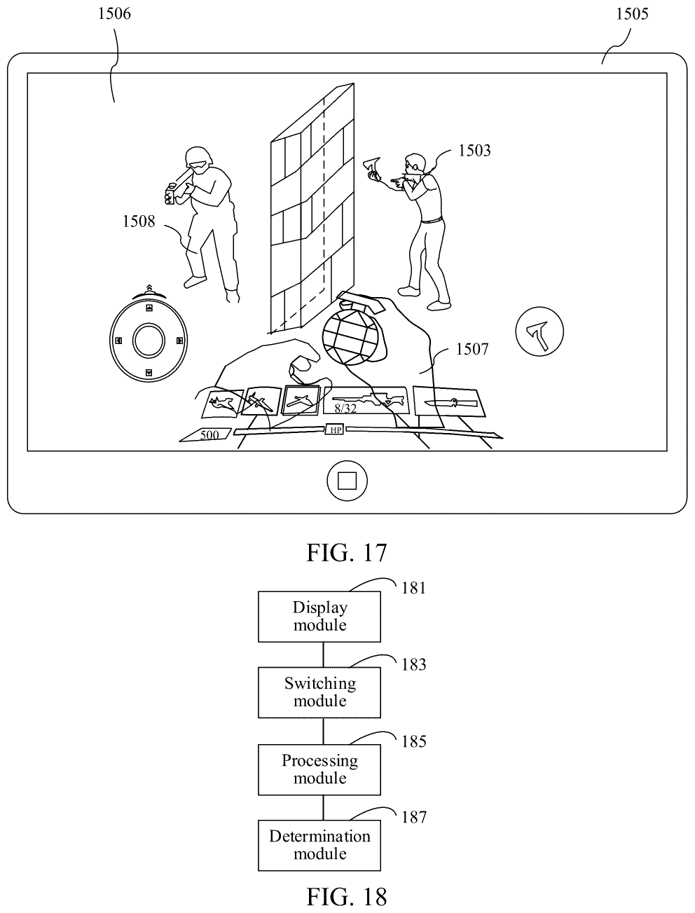

As shown in FIG. 17, a second client 1505 displays a third virtual world picture 1506. The third virtual world picture 1506 includes a picture of a virtual world observed through a third perspective of the second virtual object 1507. The third virtual object 1508 located in a target space range of the virtual world is displayed in the third virtual world picture 1506, and is not displayed in the first virtual world picture 1502 and the second virtual world picture 1504.

The target space range is an overlapping range of a field of view of the third perspective and the field of view of the second perspective, and the target space range is a non-overlapping range of the field of view of the third perspective and the field of view of the first perspective.

FIG. 18 is a structural schematic diagram of an apparatus for displaying a virtual world according to an aspect of this disclosure. The apparatus includes at least part of a display module 181, a switching module 183, a processing module 185, and a determination module 187.

The display module 181 is configured to display a first virtual world picture, the first virtual world picture including a picture of a virtual world observed through a first perspective of a first virtual object.

The switching module 183 is configured to switch the first perspective of the first virtual object to a second perspective in response to a first perspective switching operation, a field of view of the second perspective being different from a field of view of the first perspective.

The display module 181 is further configured to display a second virtual world picture, the second virtual world picture including a picture of a virtual world observed through the second perspective of the first virtual object, and in a case that a third virtual object exists within a difference set range of the field of view of the second perspective and the field of view of the first perspective, the third virtual object being invisible in the second virtual world picture.

In some aspects, the apparatus further includes the processing module 185, which is configured to skip rendering the third virtual object in the field of view of the second perspective in a case that the third virtual object of an invisible type exists in the field of view of the second perspective, to obtain the second virtual world picture.

The display module 181 is further configured to display the second virtual world picture.

The apparatus further includes the determination module 187, which is configured to determine the invisible type based on the field of view of the first perspective.

In some aspects, the processing module 185 is further configured to render a fourth virtual object in the field of view of the second perspective in a case that a fourth virtual object of a visible type further exists in the field of view of the second perspective.

The determination module 187 is further configured to determine the visible type based on the field of view of the first perspective.

In some aspects, the first perspective is bound to a first camera, and the second perspective is bound to a second camera.

The determination module 187 is further configured to: determine whether the virtual object is the visible type and/or the invisible type based on a fact that the first camera performs ray detection on the virtual object in the field of view of the first perspective;
determine a virtual object located in the field of view of the second perspective based on the second camera; and
determine a virtual object of the invisible type located in the field of view of the second perspective as the third virtual object.

In some aspects, the determination module 187 is further configured to determine a virtual object of the visible type located in the field of view of the second perspective as the fourth virtual object.

In some aspects, the determination module 187 is further configured to: emit a ray from a central point of the first camera to the virtual object in the field of view of the first perspective;
determine, as the visible type, a virtual object corresponding to a collider model that intersects with the ray; and
determine, as the invisible type, a virtual object corresponding to a collider model that does not intersect with the ray,
the virtual object being located inside the collider model.

In some aspects, the virtual object includes n key points, n being an integer greater than or equal to 1.

The determination module 187 is further configured to: emit rays from the central point of the first camera to the n key points;
determine, as the visible type, a virtual object corresponding to the collider model in which at least one of the n key points intersects with the ray; and
determine, as the invisible type, a virtual object corresponding to the collider model in which all of the n key points do not intersect with the ray.

In some aspects, the determination module 187 is further configured to select the n key points from m key points based on at least one of system performance, a posture of the virtual object, a form of the virtual object, a scene type of the virtual world, and a quantity of virtual objects in the field of view of the first perspective,
the m key points including at least two of a head key point, a left arm key point, a right arm key point, a left hand key point, a right hand key point, an abdomen key point, a left leg key point, a right leg key point, a left foot key point, a right foot key point, and a waist key point, m being a positive integer greater than or equal to 2, and m being greater than or equal to n.

In some aspects, the determination module 187 is further configured to implement the following:
in a case that the system performance is greater than or equal to a first threshold, n is equal to m; and
in a case that the system performance is less than the first threshold, the n key points include at least one of the head key point, the left hand key point, the right hand key point, the left foot key point, and the right foot key point.

In some aspects, the determination module 187 is further configured to implement the following:
in a case that the posture of the virtual object is in a standing state, the n key points include at least one of the head key point, the left hand key point, the right hand key point, the left foot key point, and the right foot key point;
in a case that the posture of the virtual object is in a prone state, the n key points include at least one of the head key point, the left arm key point, the right arm key point, the left leg key point, the right leg key point, and the waist key point;
in a case that the posture of the virtual object is in a supine state, the n key points include at least one of the head key point, the left arm key point, the right arm key point, the left leg key point, the right leg key point, and the abdomen key point; and
in a case that the posture of the virtual object is in a crouching state, the n key points include at least one of the head key point, the left arm key point, the right arm key point, the left leg key point, the right leg key point, and the waist key point.

In some aspects, the determination module 187 is further configured to implement the following:
in a case that the form of the virtual object is a human form, n is equal to m; and
in a case that the form of the virtual object is in an animal form, the n key points include at least one of the head key point, the abdomen key point, the waist key point, the left foot key point, and the right foot key point.

In some aspects, the determination module 187 is further configured to implement the following:
in a case that the type of the virtual scene is a land scene, the n key points include at least one of the head key point, the left arm key point, the right arm key point, the left hand key point, the right hand key point, the abdomen key point, the left leg key point, the right leg key point, the left foot key point, the right foot key point, and the waist key point;
in a case that the type of the virtual scene is an ocean scene, the n key points include at least one of the head key point, the left arm key point, the right arm key point, the left hand key point, the right hand key point, and the waist key point; and
in a case that the type of the virtual scene is a sky scene, the n key points include at least one of the head key point, the left arm key point, the right arm key point, the left hand key point, the right hand key point, the left leg key point, the right leg key point, the left foot key point, the right foot key point, and the abdomen key point.

In some aspects, the determination module 187 is further configured to implement the following:
in a case that the quantity of virtual objects in the field of view of the first perspective is greater than or equal to a second threshold, the n key points include at least one of the head key point, the left hand key point, the right hand key point, the left foot key point, and the right foot key point; and
in a case that the quantity of virtual objects in the field of view of the first perspective is less than a second threshold, the n key points include at least one of the head key point, the left hand key point, the right hand key point, the left foot key point, the right foot key point, the abdomen key point, and the waist key point.

In some aspects, the switching module 183 is further configured to:
switch the second perspective of the first virtual object to the first perspective in response to a second perspective switching operation; or
switch the second perspective of the first virtual object to the first perspective in response to a failure time of the first perspective switching operation.

In some aspects, the determination module 187 is further configured to stop performing ray detection on the virtual object in the field of view of the first perspective based on the first camera.

In some aspects, the first perspective of the first virtual object includes a first-person perspective of the first virtual object, and the second perspective of the first virtual object includes a third-person perspective of the first virtual object.

In some aspects, the field of view of the first perspective of the first virtual object is a subset of field of views of the second perspective of the first virtual object.

Based on the above, according to the apparatus provided in the aspects of this disclosure, switching of the perspective for observing the virtual world is supported. After the perspective is switched, even if the third virtual object exists in the difference set range between the field of view of the second perspective and the field of view of the first perspective, the third virtual object is invisible in the second virtual world picture, which helps resolve adverse impact caused by the perspective switching or the perspective change, avoids presenting information that the user is not to receive to the user, and ensures that the user does not observe, through the second perspective, the virtual object that cannot be observed from the first perspective.

The apparatus provided in the foregoing aspects is illustrated with an example of division of the foregoing functional modules in the display process of the virtual world. In actual application, the functions may be allocated to and completed by different functional modules according to requirements, namely, the internal structure of the device is divided into different functional modules, to implement all or some of the functions described above. In addition, for details of a specific implementation process, reference is made to the method aspects. Details are not described herein again.

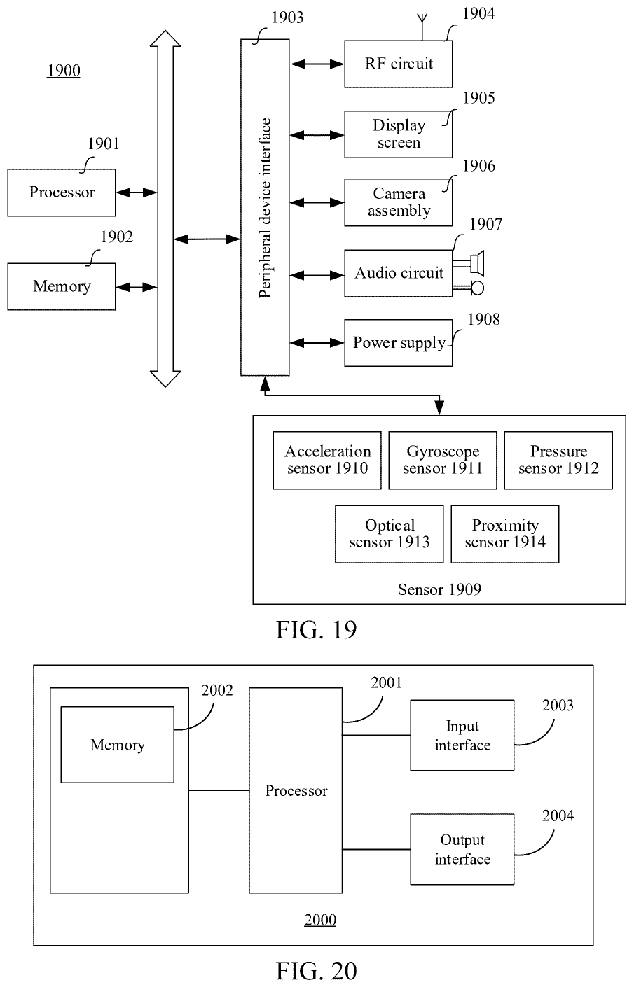

FIG. 19 is a structural block diagram of a terminal 1900 according to an aspect of this disclosure. The terminal 1900 may be at least one of a smartphone, a tablet computer, an e-book reader, a laptop computer, a desktop computer, a television, an AR terminal, a VR terminal, an MR terminal, and an XR terminal. The terminal 1900 may also be referred to as another name such as user equipment, a portable terminal, a laptop terminal, or a desktop terminal.

The terminal 1900 includes a processor 1901 (e.g., processing circuitry) and a memory 1902 (e.g., a non-transitory computer-readable storage medium).

The processor 1901 may include one or more processing cores, for example, a 4-core processor or an 8-core processor. The processor 1901 may be implemented in at least one hardware form of a digital signal processor (DSP), a field-programmable gate array (FPGA), and a programmable logic array (PLA). The processor 1901 may alternatively include a main processor and a coprocessor. The main processor is a processor configured to process data in an awake state, which is also referred to as a CPU. The coprocessor is a low-power processor configured to process data in a standby state. In some aspects, the processor 1901 may be integrated with a graphics processing unit (GPU). The GPU is configured to render and draw content that needs to be displayed on a display screen. In some aspects, the processor 1901 may further include an AR processor. The AR processor is configured to process computing operations related to AR. In some aspects, the processor 1901 may further include an artificial intelligence (AI) processor. The AI processor is configured to process computing operations related to machine learning.

The memory 1902 may include one or more computer-readable storage media. The computer-readable storage medium may be non-transitory. The memory 1902 may further include a high-speed random access memory and a nonvolatile memory, for example, one or more disk storage devices or flash storage devices. In some aspects, the non-transitory computer-readable storage medium in the memory 1902 is configured to store at least one instruction. The at least one instruction is configured for being executed by the processor 1901 to implement the method for displaying a virtual world provided in the method aspect of this disclosure.

In some aspects, the terminal 1900 may alternatively include a peripheral device interface 1903 and at least one peripheral device. The processor 1901, the memory 1902, and the peripheral device interface 1903 may be connected through a bus or a signal cable. Each peripheral device may be connected to the peripheral device interface 1903 by a bus, a signal line, or a circuit board. Specifically, the peripheral device may include at least one of a radio frequency (RF) circuit 1904, a display screen 1905, a camera assembly 1906, an audio circuit 1907, and a power supply 1908.

The peripheral device interface 1903 may be configured to connect the at least one peripheral device related to input/output (I/O) to the processor 1901 and the memory 1902. In some aspects, the processor 1901, the memory 1902, and the peripheral device interface 1903 are integrated on the same chip or circuit board. In some other aspects, any one or two of the processor 1901, the memory 1902, and the peripheral device interface 1903 may be implemented on an independent chip or circuit board, which is not limited in this aspect.

The RF circuit 1904 is configured to receive and transmit an RF signal, which is also referred to as an electromagnetic signal. The RF circuit 1904 communicates with a communication network and another communication device through the electromagnetic signal. The RF circuit 1904 converts an electric signal into an electromagnetic signal for transmission, or converts a received electromagnetic signal into an electric signal. In some aspects, the RF circuit 1904 includes an antenna system, an RF transceiver, one or more amplifiers, a tuner, an oscillator, a digital signal processor, a codec chip set, a subscriber identity module card, and the like. The RF circuit 1904 may communicate with the another terminal through at least one wireless communication protocol. The wireless communication protocol includes but is not limited to the World Wide Web, a metropolitan area network, Intranet, various generations of mobile communication networks (2G, 3G, 4G, and 5G), a wireless local area network, and/or a Wi-Fi network. In some aspects, the RF circuit 1904 may further include a near field communication (NFC)-related circuit, which is not limited in this disclosure.

The display screen 1905 is configured to display a UI. The UI may include a graph, text, an icon, a video, and any combination thereof. When the display screen 1905 is a touch display screen, the display screen 1905 further has a capability of collecting a touch signal on or above a surface of the display screen 1905. The touch signal may be inputted to the processor 1901 as a control signal for processing. In this case, the display screen 1905 may be further configured to provide a virtual button and/or a virtual keyboard, which is also referred to as a soft button and/or a soft keyboard. In some aspects, one display screen 1905 may be arranged on a front panel of the terminal 1900. In some other aspects, at least two display screens 1905 may be respectively arranged on different surfaces of the terminal 1900 or may be folded. In still other aspects, the display screen 1905 may be a flexible display screen arranged on a curved surface or a folding surface of the terminal 1900. The display screen 1905 may be even arranged as a non-rectangular irregular figure, namely, a special-shaped screen. The display screen 1905 may be made of a material such as a liquid crystal display (LCD) and an organic light-emitting diode (OLED).

The camera assembly 1906 is configured to collect an image or a video. In some aspects, the camera assembly 1906 includes a front camera and a rear camera. Generally, the front camera is arranged on the front panel of the terminal, and the rear camera is arranged on the back of the terminal. In some aspects, at least two rear cameras are arranged, which are respectively any of a main camera, a depth-of-field camera, a wide-angle camera, and a telephoto camera, to achieve background blurring through fusion of the main camera and the depth-of-field camera, panoramic photographing and VR photographing through fusion of the main camera and the wide-angle camera, or another fusion photographing function. In some aspects, the camera assembly 1906 may further include a flash. The flashlight may be a single-color-temperature flash, or may be a dual-color-temperature flash. The dual-color-temperature flash is a combination of a warm flash and a cold flash, which may be configured for light compensation at different color temperatures.

The audio circuit 1907 may include a microphone and a speaker. The microphone is configured to collect a sound wave of a user and an environment, and convert the sound wave into an electrical signal and input the electrical signal to the processor 1901 for processing, or input the electrical signal to the RF circuit 1904 to achieve voice communication. For the purpose of stereo collection or noise reduction, a plurality of microphones may be respectively arranged at different parts of the terminal 1900. The microphone may be further an array microphone or an omnidirectional acquisition microphone. The speaker is configured to convert an electrical signal from the processor 1901 or the RF circuit 1904 into a sound wave. The speaker may be a conventional film speaker, or may be a piezoelectric ceramic speaker. When the speaker is the piezoelectric ceramic speaker, the speaker can not only convert an electric signal into a sound wave audible to human beings, but also convert the electric signal into a sound wave inaudible to human beings for ranging and the like. In some aspects, the audio circuit 1907 may further include an earphone jack.

The power supply 1908 is configured to supply power to assemblies in the terminal 1900. The power supply 1908 may be an alternating current power supply, a direct current power supply, a disposable battery, or a rechargeable battery. When the power supply 1908 includes the rechargeable battery, the rechargeable battery may be a wired rechargeable battery or a wireless rechargeable battery. The wired rechargeable battery is a battery charged through a wired circuit, and the wireless rechargeable battery is a battery charged through a wireless coil. The rechargeable power supply may be further configured to support a fast charging technology.

In some aspects, the terminal 1900 further includes one or more sensors 1909. The one or more sensors 1909 include but are not limited to an acceleration sensor 1910, a gyroscope sensor 1911, a pressure sensor 1912, an optical sensor 1913, and a proximity sensor 1914.

The acceleration sensor 1910 may detect a magnitude of acceleration on three coordinate axes of a coordinate system established with the terminal 1900. For example, the acceleration sensor 1910 may be configured to detect components of gravity acceleration on the three coordinate axes. The processor 1901 may control, based on a gravity acceleration signal collected by the acceleration sensor 1910, the display screen 1905 to display the UI in a landscape view or a portrait view. The acceleration sensor 1910 may be further configured to collect movement data of a game or a user.

The gyroscope sensor 1911 may detect a body direction and a rotation angle of the terminal 1900. The gyroscope sensor 1911 may cooperate with the acceleration sensor 1911 to collect a 3D action by the user on the terminal 1900. The processor 1901 may implement the following functions according to the data collected by the gyro sensor 1911: movement sensing (for example, changing the UI based on a tilt operation of the user), image stabilization during shooting, game control, and inertial navigation.

The pressure sensor 1912 may be arranged at a side frame of the terminal 1900 and/or a lower layer of the display screen 1905. When the pressure sensor 1912 is arranged at the side frame of the terminal 1900, a holding signal of the user on the terminal 1900 may be detected. The processor 1901 performs left/right hand recognition or a quick operation based on the holding signal acquired by the pressure sensor 1912. When the pressure sensor 1912 is arranged on the lower layer of the display screen 1905, the processor 1901 controls, based on a pressure operation performed by the user on the display screen 1905, an operable control on the UI. The operable control includes at least one of a button control, a scroll-bar control, an icon control, and a menu control.

The optical sensor 1913 is configured to collect ambient light intensity. In an aspect, the processor 1901 may control display brightness of the display screen 1905 based on the ambient light intensity collected by the optical sensor 1913. Specifically, when the ambient light intensity is relatively high, the display brightness of the display screen 1905 is increased. When the ambient light intensity is relatively low, the display brightness of the display screen 1905 is reduced. In another aspect, the processor 1901 may further dynamically adjust a camera parameter of the camera assembly 1906 based on the ambient light intensity acquired by the optical sensor 1913.

The proximity sensor 1914, also referred to as a distance sensor, is usually arranged on the front panel of the terminal 1900. The proximity sensor 1914 is configured to collect a distance between the user and the front of the terminal 1900. In an aspect, when the proximity sensor 1914 detects that the distance between the user and the front of the terminal 1900 is gradually smaller, the processor 1901 controls the display screen 1905 to switch from a screen-on state to a screen-off state. When the proximity sensor 1914 detects that the distance between the user and the front surface of the terminal 1900 gradually increases, the display screen 1905 is controlled by the processor 1901 to switch from the screen-off state to the screen-on state.

The memory further includes one or more programs. The one or more programs are stored in the memory. The one or more programs include a program for performing the method for displaying a virtual world provided in the aspects of this disclosure.

A person skilled in the art may understand that, the structure shown in FIG. 19 constitutes no limitation on the terminal 1900, and the terminal may include more or fewer assemblies than those shown in the figure, or some assemblies may be combined, or a different assembly arrangement may be used.

FIG. 20 is a structural block diagram of a server 2000 according to an aspect of this disclosure.

The server 2000 generally includes a processor 2001 and a memory 2002.

The processor 2001 may include one or more processing cores, for example, a 4-core processor or an 8-core processor. The processor 2001 may be implemented in at least one hardware form of a DSP, an FPGA, and a PLA. The processor 2001 may also include a main processor and a coprocessor. The main processor is a processor configured to process data in an awake state, which is also referred to as a CPU. The coprocessor is a low-power processor configured to process data in a standby state.

In some aspects, the processor 2001 may be integrated with a GPU. The GPU is configured to render and draw content that needs to be displayed on a display screen. In some aspects, the processor 2001 may further include an artificial intelligence (AI) processor. The AI processor is configured to process computing operations related to machine learning.

The memory 2002 may include one or more computer-readable storage media. The computer-readable storage medium may be non-transitory. The memory 2002 may further include a high-speed random access memory and a nonvolatile memory, for example, one or more disk storage devices or flash storage devices. In some aspects, the non-transitory computer-readable storage medium in the memory 2002 is configured to store at least one instruction. The at least one instruction is configured for being executed by the processor 2001 to implement the method for displaying a virtual world provided in the method aspect of this disclosure.

In some aspects, the server 2000 may further include: an input interface 2003 and an output interface 2004. The processor 2001, the memory 2002, the input interface 2003, and the output interface 2004 may be connected through a bus or a signal cable. Each peripheral device may be connected to the input interface 2003 and the output interface 2004 through a bus, a signal line, or a circuit board. The input interface 2003 and the output interface 2004 may be configured to connect at least one peripheral device related to I/O to the processor 2001 and the memory 2002. In some aspects, the processor 2001, the memory 2002, the input interface 2003, and the output interface 2004 are integrated on the same chip or circuit board. In some other aspects, any one or two of the processor 2001, the memory 2002, the input interface 2003, and the output interface 2004 may be implemented on an independent chip or circuit board, which is not limited in this aspect of this disclosure.

A person skilled in the art may understand that the structure shown above constitutes no limitation on the server 2000, and the terminal may include more or fewer assemblies than those shown in the figure, or some assemblies may be combined, or a different assembly arrangement may be used.

In an aspect, a computer device is further provided. The computer device includes a processor and a memory, the memory having a computer program stored therein, the computer program being loaded and executed by the processor to implement the foregoing method for displaying a virtual world.

In an aspect, a chip is further provided, the chip including a programmable logic circuit and/or a program instruction, a server or a terminal having the chip installed therein being configured to implement the foregoing method for displaying a virtual world.

In an aspect, a computer-readable storage medium is further provided, having at least one program stored therein, the at least one program, when executed by a processor, implementing the foregoing method for displaying a virtual world. In some aspects, the foregoing computer-readable storage medium may be a read-only memory (ROM), a random access memory (RAM), a compact disc ROM (CD-ROM), a magnetic tape, a floppy disk, an optical data storage device, or the like.

In an aspect, a computer program product is further provided, including a computer program, the computer program being stored in a computer-readable storage medium, a processor reading the computer program from the computer-readable storage medium, the processor executing the computer program, to implement the foregoing method for displaying a virtual world.

What is claimed is:

1. A method for displaying a virtual environment, the method comprising:
outputting for display a first virtual scene based on a first view perspective of a first virtual object in the virtual environment;
switching the first view perspective of the first virtual object to a second view perspective based on a first perspective switching operation, a field of view of the second view perspective being different from a field of view of the first view perspective; and
outputting for display a second virtual scene based on the second view perspective of the first virtual object in the virtual environment and whether a second virtual object in the field of view of the second view perspective is in the field of view of the first view perspective, wherein
inclusion of the second virtual object in the second virtual scene is based on whether the second virtual object is included in the field of view of the first view perspective.

2. The method according to claim 1, further comprising:
determining whether the second virtual object is visible within the field of view of the first view perspective; and
outputting for display the second virtual object in the second virtual scene based on a determination that the second virtual object is visible within the field of view of the first view perspective, wherein
the second virtual object is not displayed in the second virtual scene when the second virtual object is not visible within the field of view of the first view perspective.

3. The method according to claim 2, further comprising:
determining whether a third virtual object is visible within the field of view of the first view perspective; and
outputting for display the third virtual object in the second virtual scene based on a determination that the third virtual object is visible within the field of view of the first view perspective.

4. The method according to claim 2, wherein
the first view perspective is from a first virtual camera and the second view perspective is from a second virtual camera, and
the method further comprises:
performing ray detection based on the first virtual camera to the second virtual object in the field of view of the first view perspective;
classifying the second virtual object as a visible type or an invisible type based on the ray detection; and
determining, based on the second virtual camera, whether the second virtual object is located in the field of view of the second view perspective.

5. The method according to claim 4, wherein the performing the ray detection comprises:
emitting a ray from a central point of the first virtual camera to the second virtual object in the field of view of the first view perspective;
determining that the second virtual object is of the visible type when the ray intersects with a collider model corresponding to the second virtual object; and
determining that the second virtual object is of the invisible type when the ray does not intersect with the collider model corresponding to the second virtual object.

6. The method according to claim 5, wherein the second virtual object includes n key points, n being an integer greater than or equal to 1; and
the performing the ray detection comprises:
emitting rays from the central point of the first virtual camera to the n key points of the second virtual object;
determining that the second virtual object is of the visible type when at least one of the rays to the n key points intersects with the corresponding collider model; and
determining that second virtual object is of the invisible type when none of the rays to the n key points intersects with the corresponding collider model.

7. The method according to claim 6, further comprising:
selecting the n key points from m key points based on at least one of system performance, a posture of the second virtual object, a form of the second virtual object, a scene type of the virtual environment, and a quantity of virtual objects in the field of view of the first view perspective, wherein
the m key points includes at least two of a head key point, a left arm key point, a right arm key point, a left hand key point, a right hand key point, an abdomen key point, a left leg key point, a right leg key point, a left foot key point, a right foot key point, and a waist key point, m being a positive integer greater than or equal to 2, and m being greater than or equal to n.

8. The method according to claim 7, wherein the selecting the n key points includes at least one of:
setting n equal to m when the system performance is greater than or equal to a first threshold;
selecting the n key points to include at least one of the head key point, the left hand key point, the right hand key point, the left foot key point, and the right foot key point when the system performance is less than the first threshold;
selecting the n key points to include at least one of the head key point, the left hand key point, the right hand key point, the left foot key point, and the right foot key point when the quantity of virtual objects is greater than or equal to a second threshold; or
selecting the n key points to include at least one of the head key point, the left hand key point, the right hand key point, the left foot key point, the right foot key point, the abdomen key point, and the waist key point when the quantity of virtual objects is less than the second threshold.

9. The method according to claim 1, further comprising:
switching the second view perspective of the first virtual object to the first view perspective based on at least one of a second perspective switching operation or expiration of a validity period associated with the first perspective switching operation.

10. The method according to claim 1, wherein
the first view perspective includes a first-person perspective and the second view perspective includes a third-person perspective.

11. The method according to claim 1, wherein
the field of view of the first view perspective of the first virtual object is a sub-portion of the field of view of the second view perspective of the first virtual object.

12. The method according to claim 4, further comprising:
continuously performing the ray detection during the display of the second virtual scene to update the visible type and invisible type classifications; and
updating the second virtual scene based on changes in visibility of the second virtual object from the first view perspective.

13. An apparatus for displaying a virtual environment, the apparatus comprising:
processing circuitry configured to:
output for display a first virtual scene based on a first view perspective of a first virtual object in the virtual environment;
switch the first view perspective of the first virtual object to a second view perspective based on a first perspective switching operation, a field of view of the second view perspective being different from a field of view of the first view perspective; and
output for display a second virtual scene based on the second view perspective of the first virtual object in the virtual environment and whether a second virtual object in the field of view of the second view perspective is in the field of view of the first view perspective, wherein
inclusion of the second virtual object in the second virtual scene is based on whether the second virtual object is included in the field of view of the first view perspective.

14. The apparatus according to claim 13, wherein the processing circuitry is configured to:
determine whether the second virtual object is visible within the field of view of the first view perspective; and
output for display the second virtual object in the second virtual scene based on a determination that the second virtual object is visible within the field of view of the first view perspective, wherein
the second virtual object is not displayed in the second virtual scene when the second virtual object is not visible within the field of view of the first view perspective.

15. The apparatus according to claim 14, wherein the processing circuitry is configured to:
determine whether a third virtual object is visible within the field of view of the first view perspective; and
output for display the third virtual object in the second virtual scene based on a determination that the third virtual object is visible within the field of view of the first view perspective.

16. The apparatus according to claim 14, wherein
the first view perspective is from a first virtual camera and the second view perspective is from a second virtual camera, and
the processing circuitry is configured to:
perform ray detection based on the first virtual camera to the second virtual object in the field of view of the first view perspective;
classify the second virtual object as a visible type or an invisible type based on the ray detection; and
determine, based on the second virtual camera, whether the second virtual object is located in the field of view of the second view perspective.

17. The apparatus according to claim 16, wherein the processing circuitry is configured to:
emit a ray from a central point of the first virtual camera to the second virtual object in the field of view of the first view perspective;
determine that the second virtual object is of the visible type when the ray intersects with a collider model corresponding to the second virtual object; and
determine that the second virtual object is of the invisible type when the ray does not intersect with the collider model corresponding to the second virtual object.

18. The apparatus according to claim 17, wherein the second virtual object includes n key points, n being an integer greater than or equal to 1; and
the processing circuitry is configured to:
emit rays from the central point of the first virtual camera to the n key points of the second virtual object;
determine that the second virtual object is of the visible type when at least one of the rays to the n key points intersects with the corresponding collider model; and
determine that second virtual object is of the invisible type when none of the rays to the n key points intersects with the corresponding collider model.

19. The apparatus according to claim 18, wherein the processing circuitry is configured to:
select the n key points from m key points based on at least one of system performance, a posture of the second virtual object, a form of the second virtual object, a scene type of the virtual environment, and a quantity of virtual objects in the field of view of the first view perspective, wherein
the m key points includes at least two of a head key point, a left arm key point, a right arm key point, a left hand key point, a right hand key point, an abdomen key point, a left leg key point, a right leg key point, a left foot key point, a right foot key point, and a waist key point, m being a positive integer greater than or equal to 2, and m being greater than or equal to n.

20. A non-transitory computer-readable storage medium storing instructions which, when executed by a processor, cause the processor to perform:
outputting for display a first virtual scene based on a first view perspective of a first virtual object in a virtual environment;
switching the first view perspective of the first virtual object to a second view perspective based on a first perspective switching operation, a field of view of the second view perspective being different from a field of view of the first view perspective; and
outputting for display a second virtual scene based on the second view perspective of the first virtual object in the virtual environment and whether a second virtual object in the field of view of the second view perspective is in the field of view of the first view perspective, wherein
inclusion of the second virtual object in the second virtual scene is based on whether the second virtual object is included in the field of view of the first view perspective.
